(19) United States
(12) Patent Application Publication
(10) Pub. No.: US 2026/0133410 A1
(43) Pub. Date: May 14, 2026

(54) OPTICAL ELEMENT, OPTICAL DEVICE, AND ELECTRONIC DEVICE

(71) Applicant: Semiconductor Energy Laboratory Co., Ltd., Atsugi-shi (JP)

(72) Inventors: Daiki NAKAMURA, Atsugi (JP); Hisao IKEDA, Zama (JP); Ryo HATSUMI, Hadano (JP); Tomotaka NISHIMURA, Kawasaki (JP)

(21) Appl. No.: 19/364,099

(22) Filed: Oct. 21, 2025

(30) Foreign Application Priority Data
Nov. 14, 2024 (JP) 2024-198931

(51) Int. Cl. G02B 17/08; G02B 27/28

(52) U.S. Cl. CPC G02B 17/086; G02B 27/28

(57) ABSTRACT

A high-performance optical element, an optical device, and an electronic device are provided. A first dielectric multilayer film with a small number of layers and a small stress provided in contact with one of two optical components (optical elements such as lenses) and a second dielectric multilayer film with a small number of layers and a small stress provided in contact with the other of the optical components are bonded to each other with an adhesive. With such a structure, an optical element including a dielectric multilayer film that has a large number of layers and excellent optical characteristics and is less likely to suffer from film separation is formed.

### BACKGROUND OF THE INVENTION

### 1. Field of the Invention

One embodiment of the present invention relates to an optical component, an optical device, and an electronic device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Specifically, examples of the technical field of one embodiment of the present invention disclosed in this specification include a semiconductor device, a display apparatus, a liquid crystal display apparatus, a light-emitting apparatus, a lighting device, a power storage device, a memory device, an image capturing device, a method for operating any of them, and a method for manufacturing any of them.

In this specification and the like, a semiconductor device generally means a device that can function by utilizing semiconductor characteristics. A transistor and a semiconductor circuit are embodiments of semiconductor devices. In some cases, a memory device, a display apparatus, an image capturing device, or an electronic device includes a semiconductor device.

### 2. Description of the Related Art

Goggles-type devices and glasses-type devices have been developed as electronic devices for extended reality (XR). Note that XR is a general term for virtual reality (VR), augmented reality (AR), mixed reality (MR), and the like.

Typical examples of display panels that can be used for these electronic devices include a display apparatus including a liquid crystal element and a display apparatus including an organic electroluminescent (EL) element or a light-emitting diode (LED).

A display apparatus including an organic EL element does not need a backlight, which is necessary for a liquid crystal display apparatus, and thus can have advantages such as thinness, lightweight, high contrast, and low power consumption. Patent Document 1, for example, discloses examples of an electronic device for VR using an organic EL element and an optical device used for the electronic device.

### REFERENCES

### Patent Document

[Patent Document 1] WO2024/116029

### Non-Patent Document

[Non-Patent Document 1] Takashi Koida, “High-mobility transparent conductive film”, National Institute of Advanced Industrial Science and Technology, AIST Photovoltaic Technology Research Symposium 2019, Internet URL: https://unit.aist.go.jp/rpd-envene/PV/ja/results/2019/oral/T13.pdf

### SUMMARY OF THE INVENTION

An XR device such as a goggles-type device is desired to be compact and thin for improvement of portability and wearability. Therefore, a thin catadioptric system designed to have a short focal length is used for such an electronic device.

In the catadioptric system, a half mirror, a polarizing beam splitter, and the like including an optical thin film are used. A metal thin film, a dielectric multilayer film, or the like can be used as the optical thin film, and the transmittance, the reflectance, the polarization state, or the like can be controlled by adjusting the material and the thickness.

For example, in the case where desired optical characteristics need to be exhibited at an interface between two optical components, an optical thin film is formed on one of the optical components and then bonded to the other of the optical components. In the case where the optical thin film is a multilayer film, the material, the number of layers, the thickness, and the like for obtaining the desired optical characteristics can be set appropriately by calculation using optical simulation.

Meanwhile, an ideal multilayer film in calculation is not sufficiently adhesive to an optical component in some cases because of the influence of film stress or the like. Thus, sufficient mechanical strength of bonding cannot be maintained in some cases. In addition, when film separation, a crack, or the like is caused in the multilayer film, the optical characteristics are significantly degraded.

In view of this, an object of one embodiment of the present invention is to provide a high-performance optical element. Another object is to provide an optical element functioning as a high-performance half mirror. Another object is to provide an optical element including a multilayer film that is less likely to suffer from film separation. Another object is to provide an optical device including the optical element. Another object is to provide a thin optical device having high light utilization efficiency. Another object is to provide a compact electronic device including the optical device. Another object is to provide an electronic device with low power consumption. Another object is to provide a novel electronic device.

Note that the description of these objects does not preclude the existence of other objects. One embodiment of the present invention does not need achieve all of these objects. Other objects will be apparent from and can be derived from the description of the specification, the drawings, the claims, and the like.

One embodiment of the present invention relates to a high-performance optical element and an optical device including the optical element.

One embodiment of the present invention is an optical element including a first multilayer film in contact with a first surface of a first component, a second multilayer film in contact with a second surface of a second component, and an adhesive that is between and in contact with the first multilayer film and the second multilayer film. The first multilayer film includes a stack of a first layer and a second layer with different refractive indices. The second multilayer film includes a stack of a third layer and a fourth layer with different refractive indices. The first component, the first multilayer film, the adhesive, the second component, and the second multilayer film each have a visible-light-transmitting property.

The first component and the second component can each be a lens formed of a resin material.

The first surface can have a concave surface, and the second surface can have a convex surface.

The thickness of the adhesive is preferably greater than or equal to 0.1 μm and less than or equal to 1 μm. Furthermore, a spherical spacer can be provided between the first multilayer film and the second multilayer film.

The first multilayer film and the second multilayer film can act as beam splitters with different optical characteristics.

When a reflectance of the first multilayer film is a and a reflectance of the second multilayer film is b, a relation of b=(1−2a)/(2−3a) is preferably satisfied.

The first layer and the third layer preferably include the same material, and the second layer and the fourth layer preferably include the same material.

The first layer and the third layer each preferably include a region in contact with the adhesive. Alternatively, the first layer preferably includes a region in contact with the first surface, and the third layer preferably includes a region in contact with the second surface.

Another embodiment of the present invention is an optical device including the above optical element as a half mirror and having a structure where a linear polarizing plate, a first retardation plate, the half mirror, a second retardation plate, and a reflective polarizing plate are arranged in this order.

Another embodiment of the present invention is an optical device including the above optical element as a half mirror and having a structure where a first reflective polarizing plate, a first retardation plate, the half mirror, a second retardation plate, and a second reflective polarizing plate are arranged in this order.

Another embodiment of the present invention is an electronic device including the optical device and a display apparatus. The display apparatus includes a light-emitting element and a transistor connected to the light-emitting element. The transistor includes a metal oxide in a channel formation region. The metal oxide is preferably indium oxide.

According to one embodiment of the present invention, a high-performance optical element can be provided. Alternatively, an optical element functioning as a high-performance half mirror can be provided. Alternatively, an optical element including a multilayer film that is less likely to suffer from film separation can be provided. Alternatively, an optical device including the optical element can be provided. Alternatively, a thin optical device having high light utilization efficiency can be provided. Alternatively, a compact electronic device including the optical device can be provided. Alternatively, an electronic device with low power consumption can be provided. Alternatively, a novel electronic device can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1 illustrates an optical element.

FIGS. 2A to 2C show the stress of a multilayer film.

FIGS. 3A and 3B show the spectral transmittances of multilayer films.

FIGS. 4A and 4B illustrate optical paths of a catadioptric system.

FIG. 5 illustrates a catadioptric system.

FIGS. 6A to 6H illustrate optical components of a catadioptric system.

FIGS. 7A to 7G illustrate optical components of a catadioptric system.

FIG. 8 illustrates a catadioptric system.

FIGS. 9A to 9C illustrate half mirror structures and optical paths.

FIGS. 10A and 10B illustrate a pixel of a display panel.

FIGS. 11A to 11E illustrate display panels.

FIGS. 12A and 12B illustrate a glasses-type device.

FIGS. 13A and 13B illustrate a structure example of a display panel.

FIG. 14 illustrates a structure example of a display panel.

FIG. 15 illustrates a structure example of a display panel.

FIG. 16 illustrates a structure example of a display panel.

FIG. 17 illustrates a structure example of a display panel.

FIG. 18 illustrates a structure example of a display panel.

FIG. 19 illustrates a structure example of a display panel.

FIGS. 20A and 20B illustrate a transistor.

FIGS. 21A and 21B show the carrier concentration dependence of Hall mobility, and FIG. 21C is a cross-sectional view illustrating an indium oxide film.

### DETAILED DESCRIPTION OF THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Accordingly, the present invention should not be construed as being limited to the description in the following embodiments. Note that in structures of the invention described below, the same portions or portions having similar functions are denoted by the same reference numerals in different drawings, and the description thereof is not repeated in some cases. The same components are denoted by different hatching patterns in different drawings, or the hatching patterns are omitted in some cases.

Even in the case where a single component is illustrated in a circuit diagram, the component may be composed of a plurality of parts as long as there is no functional inconvenience. For example, in some cases, a plurality of transistors that operate as a switch are connected in series or in parallel. In some cases, capacitors are divided and arranged in a plurality of positions.

One conductor has a plurality of functions such as a wiring, an electrode, and a terminal in some cases. In this specification, a plurality of names are used for the same component in some cases. Even in the case where components are illustrated in a circuit diagram as if they were directly connected to each other, the components may actually be connected to each other through one or more conductors. In this specification, even such a structure is included in direct connection.

The expression “connection” in this specification includes “electrical connection”, for example. Note that the expression “electrical connection” is used in some cases to specify the connection relation of a circuit element as an object. The term “electrical connection” includes “direct connection” and “indirect connection”. The expression “A and B are directly connected” means that A and B are connected to each other without a circuit element (e.g., a transistor or a switch; a wiring is not a circuit element) therebetween. By contrast, the expression “A and B are indirectly connected” means that A and B are connected to each other with at least one circuit element therebetween.

For example, assuming that a circuit including A and B is in operation, the circuit can be specified as “A and B are indirectly connected” as an object when electric signal transmission and reception or electric potential interaction between A and B occurs at some point during the operation period of the circuit. Note that even when neither electric signal transmission and reception nor electric potential interaction between A and B occurs at some point during the operation of the circuit, the circuit can be specified as “A and B are indirectly connected” as long as electric signal transmission and reception or electric potential interaction between A and B occurs at another point during the operation period of the circuit.

Examples of the case where the expression “A and B are indirectly connected” can be used include the case where A and B are connected to each other through a source and a drain of at least one transistor. By contrast, examples of the case where the expression “A and B are indirectly connected” cannot be used include the case where an insulator is present on the path from A to B. Specific examples thereof include the case where a capacitor is connected between A and B and the case where a gate insulating film of a transistor or the like is present between A and B. In such cases, the expression “a gate (A) of a transistor and a source or a drain (B) of the transistor are indirectly connected” cannot be used.

Another example of the case where the expression “A and B are indirectly connected” cannot be used is the case where a plurality of transistors are connected through their sources and drains on the path from A to B and a constant electric potential V is supplied from a power source, GND, or the like to a node between one of the transistors and another one of the transistors.

### Embodiment 1

In this embodiment, an optical element, an optical device, and an electronic device of embodiments of the present invention will be described.

One embodiment of the present invention is a high-performance optical element. The optical element includes a first dielectric multilayer film provided in contact with a first optical component and a second dielectric multilayer film provided in contact with a second optical component, and the first dielectric multilayer film and the second dielectric multilayer film are bonded to each other with an adhesive.

In a catadioptric system used in a VR device or the like, a half mirror is used to fold an optical path. A metal film or a dielectric multilayer film can be used for the half mirror, and a dielectric multilayer film with less visible light absorption is suitably used to increase the light utilization efficiency.

The dielectric multilayer film where materials with different refractive indices are alternately stacked can have desired optical characteristics, and in general, the optical characteristics can be improved by increasing the number of layers. However, when the total thickness of the dielectric multilayer film is increased, film separation is likely to occur due to the influence of the film stress.

In view of this, in one embodiment of the present invention, the first dielectric multilayer film with a small number of layers and a small stress provided on one of the two optical components (optical elements such as lenses) and the second dielectric multilayer film with a small number of layers and a small stress provided on the other of the optical components are bonded to each other with an adhesive. With such a structure, an optical element including a dielectric multilayer film that has a large number of layers and excellent optical characteristics and is less likely to suffer from film separation can be formed.

Note that the optical device of one embodiment of the present invention has a combined structure of a plurality of components (optical components). A mechanism in which such a structure is included in a housing is simply called a lens. It is also called a pancake lens in some cases because of its thin shape.

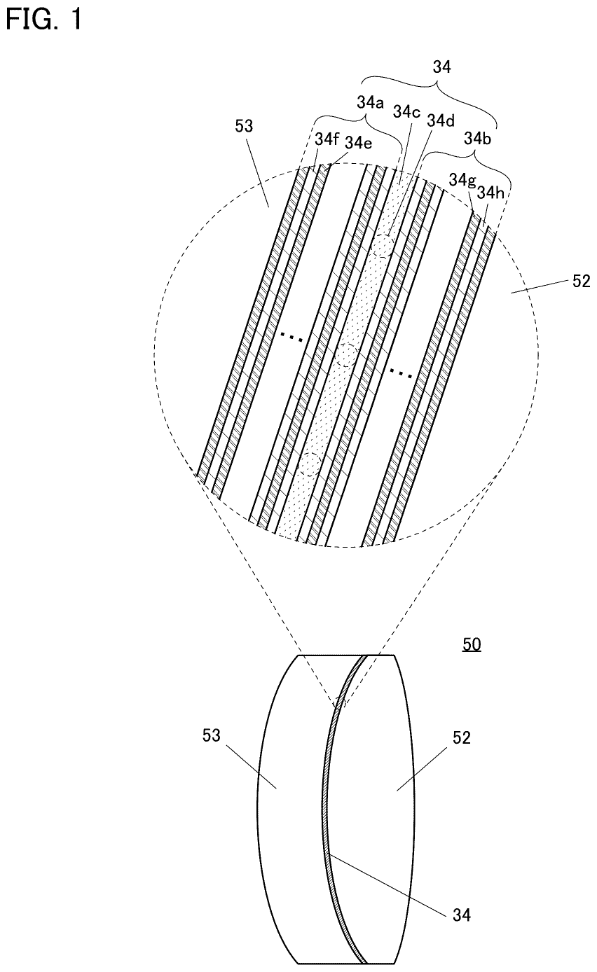

FIG. 1 is a cross-sectional view illustrating the optical element of one embodiment of the present invention, and part of the optical element is enlarged. An optical element 50 can be used for a catadioptric system included in a VR device or the like, and includes an optical component 52, an optical component 53, and a half mirror 34. The optical components 52 and 53 can each function as a lens or a support of the half mirror 34 in accordance with the function of an optical device where the optical element 50 is incorporated.

The half mirror 34 has a structure where a dielectric multilayer film 34a and a dielectric multilayer film 34b are bonded to each other with an adhesive 34c. The dielectric multilayer film 34a can have a structure where a dielectric film 34e and a dielectric film 34f with different refractive indices are alternately stacked. The dielectric multilayer film 34b can have a structure where a dielectric film 34g and a dielectric film 34h with different refractive indices are alternately stacked. Note that the structure where two kinds of dielectric films are alternately stacked is an example, and a structure where three or more kinds of dielectric films are stacked can also be used. The thickness of each dielectric film included in the dielectric multilayer films 34a and 34b is set appropriately.

Examples of a material with a low refractive index that can be used for the dielectric films 34e, 34f, 34g, and 34h include silicon oxide, silicon oxynitride, magnesium fluoride, lithium fluoride, and sodium fluoride. Examples of a material with a high refractive index that can be used for the dielectric films 34e, 34f, 34g, and 34h include titanium oxide, niobium oxide, silicon nitride, aluminum oxide, zirconium oxide, and hafnium oxide.

In general, in the case where a dielectric multilayer film such as a half mirror is provided between a pair of optical components, the dielectric multilayer film is provided on one of the optical components, and then bonded to the other of the optical components with an adhesive. Although surfaces with high flatness can be bonded by optical contact (direct bonding) without an adhesive in some cases, surfaces with curvatures are bonded with an adhesive because it is difficult to precisely match their curvatures.

Here, the material, the number of layers, the thickness, and the like of the dielectric multilayer film for obtaining desired optical characteristics can be set appropriately by calculation using optical simulation. In many cases, the optical characteristics can be improved by increasing the number of layers.

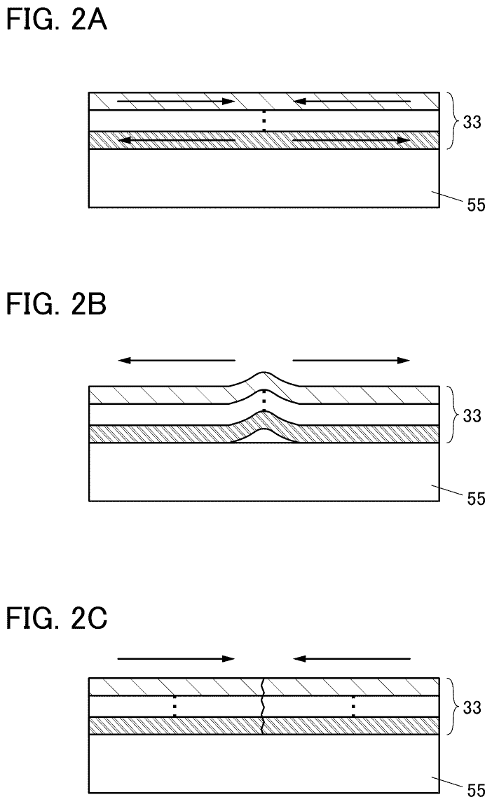

However, since the optical simulation ignores the film stress, it is difficult to actually form an ideal multilayer film as calculated. FIGS. 2A to 2C show the film stress of the dielectric multilayer film 33 formed over a substrate 55. Here, the substrate 55 is much thicker and more rigid than the dielectric multilayer film 33. The dielectric film is formed mainly by a gas phase method such as evaporation, and the stress acts in the dielectric multilayer film 33 depends on the inherent physical properties, the film formation conditions, the number of stacked layers, and the like of the dielectric films, in addition to the shape and physical properties of the substrate 55 over which the dielectric films are formed.

Ideally, as illustrated in FIG. 2A, the stress of the whole dielectric multilayer film 33 is preferably reduced by, for example, alternately stacking materials different in the stress direction in a film form (indicated by arrows in the drawing). However, the structure of the dielectric multilayer film 33 actually formed rarely matches such an ideal structure, and in most cases, a compressive or tensile stress acts in the dielectric multilayer film 33. A larger number of stacked layers, i.e., a larger total thickness, of the dielectric multilayer film 33 leads to a larger film stress.

FIG. 2B shows deformation of the film that occurs when a relatively large compressive stress (a stretching force of the film) acts in the dielectric multilayer film 33. Due to the compressive stress, the dielectric multilayer film 33 is deformed to be raised partly and separated from the substrate 55 in some cases.

FIG. 2C shows deformation of the film that occurs when a relatively large tensile stress (a shrinking force of the film) acts in the dielectric multilayer film 33. The tensile stress might cause a crack in the dielectric multilayer film 33, and if the crack develops, the dielectric multilayer film 33 is separated from the substrate 55 in some cases.

The adhesion of the film to the substrate 55 also depends on the film formation conditions. For example, the adhesion of the film can be improved by increasing the substrate temperature at the time of film formation or modifying the formation surface by plasma treatment. In the case where the optical component corresponding to the substrate 55 is made of glass or the like having high heat resistance, the adhesion of the film can be relatively high.

However, in the case where the optical component is made of a resin having low heat resistance, the film formation temperature cannot be sufficiently increased. Thus, film separation illustrated in FIG. 2B or FIG. 2C is likely to occur. Furthermore, degradation such as coloring is caused by plasma treatment in some cases. A wearable device worn on a body is desirably lightweight. Therefore, a lightweight lens made of a resin is preferably used in an optical device used for a VR device or the like.

As described above, main factors of film separation are stress related to the total thickness of the multilayer film and the adhesion of the film. Film separation occurs when the stress is higher than the threshold value or the adhesion of the film is lower than or equal to the threshold value, and film separation does not occur when the stress is lower than or equal to the threshold value and the adhesion of the film is higher than the threshold value. In addition, it can be said that the threshold value depends on the number of layers in the multilayer film on the assumption that the adhesion of the film is increased as much as possible. Thus, in one embodiment of the present invention, desired optical characteristics are obtained by bonding multilayer films whose number of layers (total thickness) is limited so that the stress does not exceed the threshold value.

That is, as illustrated in FIG. 1, the dielectric multilayer film 34a with the number of layers that does not cause the stress to exceed the threshold value is formed on the optical component 53, the dielectric multilayer film 34b with the number of layers that does not cause the stress to exceed the threshold value is formed on the optical component 52, and the dielectric multilayer films are bonded to each other with the adhesive 34c. The adhesive is in a liquid phase before curing, and acts to absorb the stress of one of the dielectric multilayer films 34a and 34b, preventing transmission of the stress to the other. Thus, the bonding does not increase the film stress of the whole multilayer film and does not cause film separation or the like.

At this time, by making the adhesive 34c as thin as possible, a half mirror with the structure of the dielectric multilayer film 34a/the adhesive 34c/the dielectric multilayer film 34b can have comparable performance to a half mirror formed of one dielectric multilayer film. Note that in this specification, the description of a component A/a component B/a component C, for example, means a structure where the components A and B are in contact with each other and the components B and C are in contact with each other.

Note that the half mirror refers to a mirror whose reflectance and transmittance are both 50% in a narrow sense; however, the half mirror in this specification is not limited thereto. A catadioptric system includes an optical path where light passes through a half mirror and then is reflected. Thus, the light utilization efficiency is the product of the reflectance and the transmittance; however, since the reflectance+the transmittance equals approximately 1, when one of the reflectance and the transmittance becomes smaller, the other becomes larger. That is, in a catadioptric system where a half mirror is used twice for reflection and transmission, the light utilization efficiency does not change largely even when the reflectance and the transmittance are each deviated from 50%. Accordingly, the reflectance and transmittance of the half mirror used in the catadioptric system are each not limited to 50% and can be, for example, 40% to 60% in the wavelength range of light to be used.

Next, results of simulation on a structure corresponding to the dielectric multilayer film 34a/the adhesive 34c/the dielectric multilayer film 34b and assumed to function as a half mirror are described. For the simulation, Essential Macleod, which is simulation software produced by Thin Film Center Inc., was used.

For the simulation, as shown in Table 1, models having a structure of the optical component 53/the dielectric multilayer film 34a/the adhesive 34c/the dielectric multilayer film 34b/the optical component 52 and different thicknesses of the adhesive were used. The optical components 53 and 52 are made of a material with a refractive index n of 1.5, the dielectric multilayer films 34a and 34b are each formed of a three-layer stack of TiO₂ and SiO₂, the adhesive 34c is made of a resin, and the total number of layers of the dielectric multilayer film 34a, the dielectric multilayer film 34b, and the adhesive 34c is seven. Examples of the material with a refractive index n of 1.5 include glass and a resin.

TABLE 1

| | | | Thickness [nm] | | | |
|---|---|---|---|---|---|---|
| | Layer | | Adhesive | Adhesive | Adhesive | Adhesive |
| Structure | No. | Material | 100 nm | 500 nm | 1000 nm | 2000 nm |
| Optical component 53 | — | n = 1.5 | — | — | — | — |
| Dielectric multilayer | 1 | TiO₂ | 31.3 | 54.39 | 37.63 | 30.34 |
| film 34a | 2 | SiO₂ | 37.29 | 89.02 | 27.28 | 40.18 |
| | 3 | TiO₂ | 41.68 | 43.43 | 46.97 | 32.24 |
| Adhesive 34c | 4 | Resin | 100.06 | 499.87 | 1000.08 | 2000.03 |
| Dielectric multilayer | 5 | TiO₂ | 60.46 | 94.61 | 62.89 | 66.07 |
| film 34b | 6 | SiO₂ | 79.73 | 139.64 | 94.39 | 90.96 |
| | 7 | TiO₂ | 85.75 | 94.62 | 62.7 | 53.54 |
| Optical component 52 | — | n = 1.5 | — | — | — | — |
| | | Total: | 436.27 | 1015.58 | 1331.94 | 2313.36 |

For comparison, simulation was also performed on a structure (Ref.) without bonding shown in Table 2. In Ref., a total of seven layers are used with the adhesive 34c in the layer No. 4 replaced with SiO₂.

TABLE 2

| | Layer | | Thickness |
|---|---|---|---|
| Structure | No. | Material | [nm] |
| Optical component 53 | — | n = 1.5 | — |
| Dielectric multilayer | 1 | TiO₂ | 33.24 |
| film (Ref.) | 2 | SiO₂ | 48.61 |
| | 3 | TiO₂ | 48.69 |
| | 4 | SiO₂ | 88.7 |
| | 5 | TiO₂ | 75.59 |
| | 6 | SiO₂ | 95.48 |
| | 7 | TiO₂ | 92.54 |
| Optical component 52 | — | n = 1.5 | |
| | | Total: | 482.85 |

Note that the refractive index n of each material used for the simulation is as shown in Table 3. The thickness of each layer of the dielectric multilayer film shown in Tables 1 and 2 is an optimal value calculated by simulation so that both the reflectance and the transmittance are around 50% in the visible light region.

TABLE 3

| | Refractive |
|---|---|
| | index n |
| TiO₂ | 2.34867 |
| SiO₂ | 1.4618 |
| Adhesive | 1.5 |

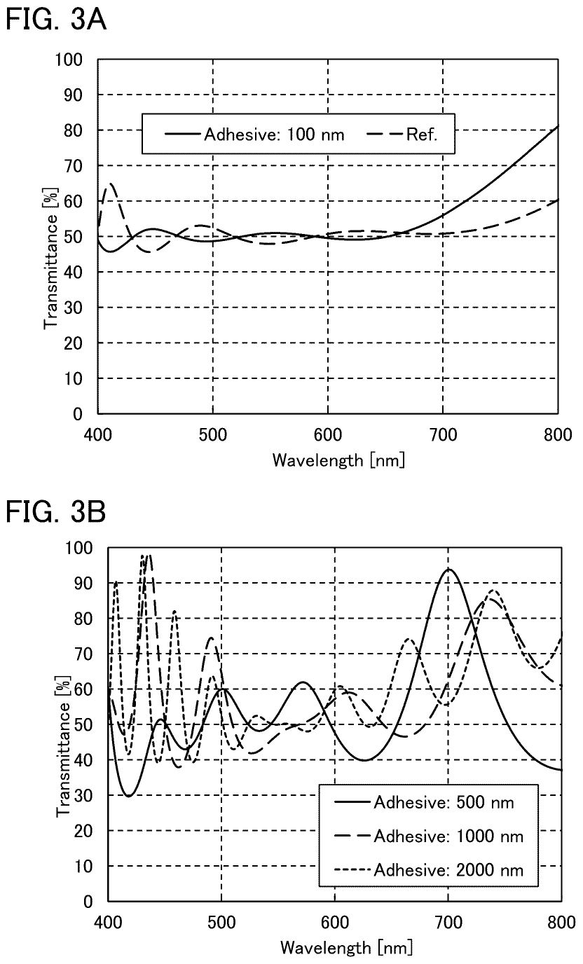

FIG. 3A shows simulation results obtained by comparing the spectral transmittances of the structure with the 100-nm-thick adhesive shown in Table 1 and the structure (Ref.) without bonding. As shown in Table 3, the adhesive has a refractive index close to that of SiO₂; thus, it is found that the adhesive acts like a SiO₂ layer when having a thickness close to that of the SiO₂ layer, allowing the structure with two bonded dielectric multilayer films to have optical characteristics comparable to those of one dielectric multilayer film.

FIG. 3B shows simulation results obtained by comparing the spectral transmittances of the structures with the 500-nm-thick adhesive, the 1000-nm-thick adhesive, and the 2000-nm-thick adhesive shown in Table 1. Although the waves include more peaks and troughs due to interference as compared to the structure with the 100-nm-thick adhesive, in the visible light range, influence of the interference becomes small when the thickness of the adhesive is less than or equal to 1000 nm.

Thus, the thickness of the adhesive 34c is preferably greater than or equal to 0.1 μm and less than or equal to 1 μm to make the structure act as one half mirror.

Since the adhesive 34c is in a liquid phase before curing, it is very difficult to uniformize a gap between the multilayer films only with the adhesive 34c. Thus, as illustrated in FIG. 1, spherical spacers 34d are preferably dispersed in the adhesive 34c to uniformize the gap between the multilayer films. As the spacer 34d, it is possible to use a spacer having a diameter greater than or equal to 0.1 μm and less than or equal to 1 μm and formed of the same material as the layer constituting the multilayer film or the adhesive or a material (e.g., silicon oxide) with a refractive index equivalent to that of the layer constituting the multilayer film or the adhesive.

Note that the light utilization efficiency of the half mirror used in the catadioptric system becomes the maximum (25%) when the transmittance (or reflectance) is 50%; however, the minimum light utilization efficiency is 24% when the transmittance (or reflectance) is 40% to 60%, and 21% even when the transmittance (or reflectance) is 30% to 70%.

A display panel emits light with specific wavelengths of R (red light with a wavelength of 620 nm to 630 nm, for example), G (green light with a wavelength of 520 nm to 530 nm, for example), and B (blue light with a wavelength of 450 nm to 460 nm, for example); thus, it can be said that the properties of the half mirror only need to be effective for the center wavelength and its vicinity of the light. Thus, the half mirror does not need to have a transmittance (or reflectance) of around 50% in the entire visible light range, and can be used even with influence of interference as along as the required conditions are satisfied.

Thus, even when the thickness of the adhesive 34c is greater than or equal to 1 μm, the half mirror action can be achieved. Note that multiple reflection occurs between the dielectric multilayer films 34a and 34b in the case where the adhesive 34c is thick; thus, it is preferable to consider the dielectric multilayer films 34a and 34b as independent beam splitters and make their optical characteristics different.

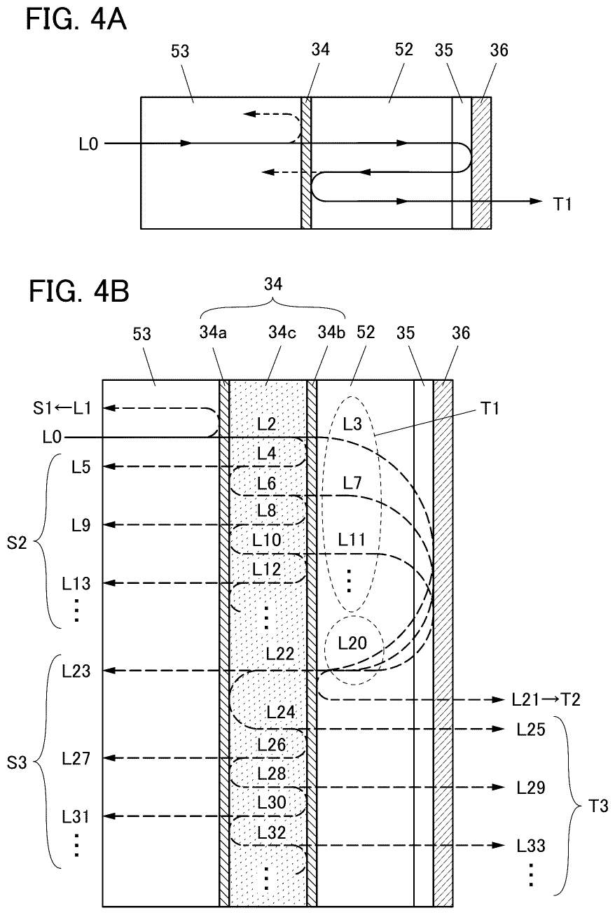

FIG. 4A illustrates some optical components and optical paths of a catadioptric system. FIG. 4A illustrates the structure in FIG. 1 (the optical component 53/the half mirror 34/the optical component 52) and a circular polarizing plate (a retardation plate 35 and a reflective polarizing plate 36) light passing through the structure enters. Note that the polarization conversion in the catadioptric system is not described here, and will be described later in detail.

As illustrated in FIG. 4A, when the half mirror 34 is regarded as one component, incident light L0 passes through the half mirror 34, is reflected by the reflective polarizing plate 36, is reflected by the half mirror 34, and passes through the reflective polarizing plate 36.

Meanwhile, in the case where the dielectric multilayer films 34a and 34b act as independent beam splitters, multiple reflection between the dielectric multilayer films 34a and 34b needs to be taken into account for the above optical path.

FIG. 4B illustrates optical paths including multiple reflection that occurs between the dielectric multilayer films 34a and 34b in the case where the half mirror 34 has the structure of the dielectric multilayer film 34a/the adhesive 34c/the dielectric multilayer film 34b in FIG. 4A.

Here, the dielectric multilayer film 34a has a reflectance of a and a transmittance of 1-a. The dielectric multilayer film 34b has a reflectance of b and a transmittance of 1-b. When the light L0 enters from the optical component 53 side, light reflected by the dielectric multilayer film 34a and returning to the optical component 53 is denoted by S1, light reflected by the dielectric multilayer film 34b and returning to the optical component 53 through the dielectric multilayer film 34a is denoted by S2, and light reflected by the reflective polarizing plate 36 and returning to the optical component 53 through the dielectric multilayer films 34a and 34b is denoted by S3. Furthermore, light passing through the dielectric multilayer films 34a and 34b is denoted by T1, light reflected by the dielectric multilayer film 34b and passing through the reflective polarizing plate 36 is denoted by T2, and light reflected by the dielectric multilayer film 34a and passing through the dielectric multilayer film 34b and the reflective polarizing plate 36 is denoted by T3. In addition, specific transmitted light and reflected light between the optical components are denoted by L1 to L33 for convenience.

First, the light L0 entering from the optical component 53 side is split into the light L1 reflected by the dielectric multilayer film 34a and the light L2 passing through the dielectric multilayer film 34a. Here, since the dielectric multilayer film 34a has the reflectance of a and the transmittance of 1-a, when L0=1, the light L1 and the light L2 are expressed by Formula 1 and Formula 2, respectively.

$$L 1 = a \qquad [ Formula 1 ]$$

$$L 2 = 1 - a \qquad [ Formula 2 ]$$

The light L2 is split into the light L3 passing through the dielectric multilayer film 34b and the light L4 reflected by the dielectric multilayer film 34b. Here, since the dielectric multilayer film 34b has the reflectance of b and the transmittance of 1-b, the light L3 and the light L4 are expressed by Formula 3 and Formula 4, respectively.

$$L 3 = ( 1 - a ) ( 1 - b ) \qquad [ Formula 3 ]$$

$$L 4 = b ( 1 - a ) \qquad [ Formula 4 ]$$

The light L4 is split into the light L5 passing through the dielectric multilayer film 34a and the light L6 reflected by the dielectric multilayer film 34a. Thus, the light L5 and the light L6 are expressed by Formula 5 and Formula 6, respectively.

$$L 5 = {b ( 1 - a )}^{2} \qquad [ Formula 5 ]$$

$$L 6 = ab ( 1 - a ) \qquad [ Formula 6 ]$$

The light L6 is split into the light L7 passing through the dielectric multilayer film 34b and the light L8 reflected by the dielectric multilayer film 34b. Thus, the light L7 and the light L8 are expressed by Formula 7 and Formula 8, respectively.

$$L 7 = a ( 1 - a ) ( 1 - b ) \qquad [ Formula 7 ]$$

$$L 8 = {ab}^{2} ( 1 - a ) \qquad [ Formula 8 ]$$

The light L8 is split into the light L9 passing through the dielectric multilayer film 34a and the light L10 reflected by the dielectric multilayer film 34a. Thus, the light L9 and the light L10 are expressed by Formula 9 and Formula 10, respectively.

$$L 9 = {{ab}^{2} ( 1 - a )}^{2} \qquad [ Formula 9 ]$$

$$L 10 = {a}^{2} {b}^{2} ( 1 - a ) \qquad [ Formula 10 ]$$

The light L10 is split into the light L11 passing through the dielectric multilayer film 34b and the light L12 reflected by the dielectric multilayer film 34b. Thus, the light L11 and the light L12 are expressed by Formula 11 and Formula 12, respectively.

$$L 11 = {a}^{2} {b}^{2} ( 1 - a ) ( 1 - b ) \qquad [ Formula 11 ]$$

$$L 12 = {a}^{2} {b}^{3} ( 1 - a ) \qquad [ Formula 12 ]$$

The light L12 is split into the light L13 passing through the dielectric multilayer film 34a and light reflected by the dielectric multilayer film 34a. Thus, the light L13 is expressed by Formula 13, and light due to multiple reflection is generated after that in a similar manner. Here, when the light L0 enters from the optical component 53 side, the light S1 reflected by the dielectric multilayer film 34a and returning to the optical component 53 is expressed by Formula 14 according to Formula 1.

$$S 1 = L 1 = a \qquad [ Formula 14 ]$$

$$L 13 = {a}^{2} {{b}^{3} ( 1 - a )}^{2} \qquad [ Formula 13 ]$$

The light S2 reflected by the dielectric multilayer film 34b and returning to the optical component 53 through the dielectric multilayer film 34a can be regarded as an infinite geometric sequence with an initial term b(1-a)² and a common ratio ab according to Formulae 5, 9, and 13; thus, Formula 15 is obtained from the formula for the sum of the infinite geometric sequence.

$$S 2 = {b ( 1 - a )}^{2} / ( 1 - ab ) \qquad [ Formula 15 ]$$

The light T1 passing through the dielectric multilayer films 34a and 34b can be regarded as an infinite geometric sequence with an initial term (1-a) (1-b) and the common ratio ab according to Formulae 3, 7, and 11; thus, Formula 16 is obtained from the formula for the sum of the infinite geometric sequence.

$$T 1 = ( 1 - a ) ( 1 - b ) / ( 1 - ab ) \qquad [ Formula 16 ]$$

Here, when the light T1 is reflected by the reflective polarizing plate 36 and the reflected light is referred to as the light L20, the light L20 is reflected by the dielectric multilayer film 34b and split into the light L21 passing through the reflective polarizing plate 36 and the light L22 passing through the dielectric multilayer film 34b. Thus, the light L21 and the light L22 are expressed by Formula 17 and Formula 18, respectively.

$$L 21 = b ( 1 - a ) ( 1 - b ) / ( 1 - ab ) \qquad [ Formula 17 ]$$

$$L 22 = ( 1 - a ) {( 1 - b )}^{2} / ( 1 - ab ) \qquad [ Formula 18 ]$$

The light L22 is split into the light L23 passing through the dielectric multilayer film 34a and the light L24 reflected by the dielectric multilayer film 34a. Thus, the light L23 and the light L24 are expressed by Formula 19 and Formula 20, respectively.

$$L 23 = {( 1 - a )}^{2} {( 1 - b )}^{2} / ( 1 - ab ) \qquad [ Formula 19 ]$$

$$L 24 = a ( 1 - a ) {( 1 - b )}^{2} / ( 1 - ab ) \qquad [ Formula 20 ]$$

The light L24 is split into the light L25 passing through the dielectric multilayer film 34b and light L26 reflected by the dielectric multilayer film 34b. Thus, the light L25 and the light L26 are expressed by Formula 21 and Formula 22, respectively.

$$L 25 = a ( 1 - a ) {( 1 - b )}^{3} / ( 1 - ab ) \qquad [ Formula 21 ]$$

$$L 26 = a ( 1 - a ) {( 1 - b )}^{2} / ( 1 - ab ) \qquad [ Formula 22 ]$$

The light L26 is split into the light L27 passing through the dielectric multilayer film 34a and the light L28 reflected by the dielectric multilayer film 34a. Thus, the light L27 and the light L28 are expressed by Formula 23 and Formula 24, respectively.

$$L 27 = {ab ( 1 - a )}^{2} {( 1 - b )}^{2} / ( 1 - ab ) \qquad [ Formula 23 ]$$

$$L 28 = {a}^{2} b ( 1 - a ) {( 1 - b )}^{2} / ( 1 - ab ) \qquad [ Formula 24 ]$$

The light L28 is split into the light L29 passing through the dielectric multilayer film 34b and the light L30 reflected by the dielectric multilayer film 34b. Thus, the light L29 and the light L30 are expressed by Formula 25 and Formula 26, respectively.

$$L 29 = {a}^{2} b ( 1 - a ) {( 1 - b )}^{3} / ( 1 - ab ) \qquad [ Formula 25 ]$$

$$L 30 = {a}^{2} {b}^{2} ( 1 - a ) {( 1 - b )}^{2} / ( 1 - ab ) \qquad [ Formula 26 ]$$

The light L30 is split into the light L31 passing through the dielectric multilayer film 34a and the light L32 reflected by the dielectric multilayer film 34a. Thus, the light L31 and the light L32 are expressed by Formula 27 and Formula 28, respectively.

$$L 31 = {a}^{2} {{b}^{2} ( 1 - a )}^{2} {( 1 - b )}^{2} / ( 1 - ab ) \qquad [ Formula 27 ]$$

$$L 32 = {a}^{3} {b}^{2} ( 1 - a ) {( 1 - b )}^{2} / ( 1 - ab ) \qquad [ Formula 28 ]$$

The light L32 is split into the light L33 passing through the dielectric multilayer film 34b and light reflected by the dielectric multilayer film 34b. Thus, the light L33 is expressed by Formula 29, and light due to multiple reflection is generated after that in a similar manner.

$$L 33 = {a}^{3} {b}^{2} ( 1 - a ) {( 1 - b )}^{3} / ( 1 - ab ) \qquad [ Formula 29 ]$$

Here, the light T2 reflected by the dielectric multilayer film 34b and passing through the reflective polarizing plate 36 is expressed by Formula 30 according to Formula 17.

$$T 2 = L 21 = b ( 1 - a ) ( 1 - b ) / ( 1 - ab ) \qquad [ Formula 30 ]$$

The light S3 reflected by the reflective polarizing plate 36 and returning to the optical component 53 through the dielectric multilayer films 34b and 34a can be regarded as an infinite geometric sequence with an initial term (1−a)²(1−b)²/(1−ab) and the common ratio ab according to Formulae 19, 23, and 27; thus, Formula 31 is obtained from the formula for the sum of the infinite geometric sequence.

$$S 3 = {( 1 - a )}^{2} {( 1 - b )}^{2} / {( 1 - ab )}^{2} \qquad [ Formula 31 ]$$

The light T3 reflected by the dielectric multilayer film 34a and passing through the dielectric multilayer film 34b and the reflective polarizing plate 36 can be regarded as an infinite geometric sequence with an initial term a (1−a)(1−b)³/(1−ab) and the common ratio ab according to Formulae 21, 25, and 29; thus, Formula 32 is obtained from the formula for the sum of the infinite geometric sequence.

$$T 3 = a ( 1 - a ) {( 1 - b )}^{3} / {( 1 - ab )}^{2} \qquad [ Formula 32 ]$$

Here, the total reflectance S of the dielectric multilayer films 34a and 34b corresponds to the sum of the reflectances of S1, S2, and S3, and thus is expressed by Formula 33 according to Formulae 14, 15, and 31.

$$S = 1 - ( ( 1 - a ) ( 1 - b ) ( a - 2 ab + b ) / {( 1 - ab )}^{2} \qquad [ Formula 33 ]$$

The total transmittance T of the dielectric multilayer films 34a and 34b corresponds to the sum of the transmittances of T2 and T3, and thus is expressed by Formula 34 according to Formulae 30 and 32.

$$T = ( 1 - a ) ( 1 - b ) ( a - 2 ab + b ) / {( 1 - ab )}^{2} \qquad [ Formula 34 ]$$

Here, when one half mirror is considered, the half mirror is used twice for transmission and reflection in the catadioptric system; thus, the light utilization efficiency is the product of a reflectance of x and a transmittance of 1-x, and has the maximum value of 25% when x is 0.5 (x(1-x)=0.25).

In the case where the half mirror is formed using the dielectric multilayer films 34a and 34b acting as independent beam splitters, the light utilization efficiency has an extremum (the maximum value of 0.25) when Formula 35 with which the differential value of Formula 34 is 0 is satisfied.

$$b = ( 1 - 2 a ) / ( 2 - 3 a ) \qquad [ Formula 35 ]$$

Thus, examples of the combination of a and b in Formula 35 include a=0% and b=50%, a=25% and b=40%, a=30% and b=36.36%, and a=40% and b=25%.

That is, when Formula 35, where a and b are respectively the reflectances of the dielectric multilayer films 34a and 34b, is satisfied, the light utilization efficiency can be 25% as in the case of using one half mirror.

In the above manner, a dielectric multilayer film provided on one of the two optical components and a dielectric multilayer film provided on the other of the optical components are bonded to each other with an adhesive, thereby forming an optical element including a dielectric multilayer film that has a large number of layers and excellent optical characteristics and is less likely to suffer from film separation. This structure enables, overcoming the film separation issue, formation of a multilayer film with a thickness that cannot be achieved by a conventional method in which different films are alternately stacked, thereby increasing the design flexibility. Making the two multilayer films symmetric allows for sharing the time-taking step of forming the multilayer film, and thus can reduce the film formation time by approximately half. Accordingly, the manufacturing cost can also be reduced.

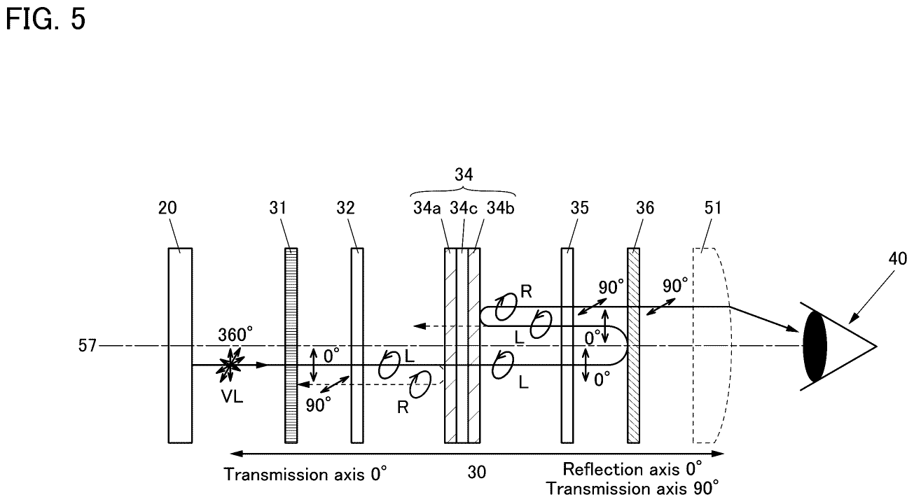

Next, a specific structure of the catadioptric system is described with reference to FIG. 5.

FIG. 5 illustrates a display panel 20 and a catadioptric system 30 included in an electronic device. FIG. 5 illustrates an optical path of visible light that is emitted from the display panel 20 and reaches an eye 40. Note that the shapes and positions of the components illustrated in FIG. 5 are examples.

In the catadioptric system 30, a linear polarizing plate 31, a retardation plate 32, the half mirror 34, the retardation plate 35, the reflective polarizing plate 36, and a lens 51 are arranged in one direction in this order from the display panel 20 side, and an optical axis 57 passes through their centers. Note that each combination of the polarizing plate and the retardation plate (the combination of the linear polarizing plate 31 and the retardation plate 32 and that of the retardation plate 35 and the reflective polarizing plate 36) is also referred to as a circularly polarizing plate, which converts non-polarized light into circularly polarized light.

Although FIG. 5 illustrates an example where the lens 51 is positioned between the reflective polarizing plate 36 and the eye 40, one embodiment of the present invention is not limited thereto. The lens 51 can be provided at another position, or a plurality of lenses including the lens 51 can be provided. The lens 51 or the like can be used also as a support of another component of the catadioptric system 30.

Although the components of the catadioptric system 30 are illustrated in FIG. 5 to be apart from each other for clear description of the optical path and the polarization state, one embodiment of the present invention is not limited thereto. Some adjacent components can be placed proximate to each other.

When the structure where adjacent components are proximate to each other is employed, the components are preferably bonded to each other with an optical adhesive that has high transmittance with respect to the wavelength of light to be used (in one embodiment of the present invention, the wavelength range of visible light or the wavelength range from 430 nm to 780 nm), no absorption of specific polarized light, and no birefringence. Alternatively, the another component may be formed on and in contact with the one component by a coating method, not by bonding. Alternatively, without using an adhesive or the like between the one component and the another component, the components may be placed in contact with each other. Alternatively, a space may be provided between the one component and the another component.

An anti-reflection layer may be provided on the surface of a component that transmits light and has an interface with the air. Since unnecessary reflection on a surface of the component (an interface between the air and the component) is prevented, light utilization efficiency can be improved and generation of stray light can be inhibited. Note that an anti-reflection layer is not needed for the half mirror, which also has a reflecting action, and the reflective polarizing plate.

As the anti-reflection layer, an anti-reflection film or a dielectric multilayer film can be used. For example, a dielectric multilayer film is preferably provided on a curved surface like a lens surface, to which a film is not easily attached. In the case of a component having a flat surface, either an anti-reflection film or a dielectric multilayer film may be provided. Note that in the case where the component in which the anti-reflection layer is formed of a resin or the like, the component is thermally damaged in the formation process of the dielectric multilayer film in some cases. In such a case, an anti-reflection film is preferably provided over the component with an adhesive therebetween.

For the anti-reflection film, there are a type of canceling light by interference of reflected light and a moth-eye type in which minute projections formed on a surface causes a continuously changed refractive index. In either type, it is preferable to use a film that is not formed by a stretching process as a base film. A film formed by a stretching process has optical anisotropy in some cases and thus may change the polarization state in some cases. It can be said that a moth-eye type is preferably used because of its small angular dependence and small wavelength dependence.

With use of the catadioptric system 30 having such a structure, light emitted from the display panel 20 is converted into linearly polarized light or circularly polarized light to be utilized, whereby reflection and transmission can be selectively performed with a component placed on an optical path. Thus, the optical path length can be ensured in a limited space, and the catadioptric system 30 can be downsized.

Next, the components of the display panel 20 and the catadioptric system 30 are described in detail.

As the display panel 20, a liquid crystal panel including a liquid crystal element, an organic EL panel including an organic EL element, an LED panel including a micro LED, or the like can be used. In particular, an organic EL panel is preferably used because a self-luminous and high-resolution display portion is easily formed. In this specification and the like, a light-emitting diode whose chip area is less than or equal to 10000 μm² is referred to as a micro LED. Note that the LED panel is not limited to the micro LED; a light-emitting diode whose chip area is greater than 10000 μm² and less than or equal to 1 mm² (also referred to as a mini LED) may be used, for example. In this embodiment, an example where an organic EL panel is used is described.

The linear polarizing plate 31 can transmit one linearly polarized light from light oscillating in 360° all directions (non-polarized light). As the linear polarizing plate 31, a thin film with uniaxial alignment of iodine or dye, a wire grid polarizing plate, or a dielectric multilayer film can be used, for example.

Note that although description is given here on the assumption that the transmission axis of the linear polarizing plate 31 is 0°, 0° is not an absolute value, but a reference value. That is, the polarization plane of the linearly polarized light passing through the linear polarizing plate 31 is regarded as 0°. Accordingly, for example, 90° linearly polarized light in this embodiment refers to linearly polarized light obtained by rotating the polarization plane of the linearly polarized light passing through the linear polarizing plate 31 by 90°.

The retardation plate 32 has a function of converting linearly polarized light into circularly polarized light. Here, a λ/4 plate (a quarter-wave plate) is used as the retardation plate 32. The λ/4 plate is overlaid with the linear polarizing plate 31 such that the angle of the slow axis of the λ/4 plate with respect to the axis of the linearly polarized light extracted by the linear polarizing plate 31 becomes 45°, whereby a right-handed circularly polarized light (right circularly polarized light) is obtained. The λ/4 plate is overlaid with the linear polarizing plate 31 such that the angle of the slow axis of the λ/4 plate with respect to the axis of the linearly polarized light extracted by the linear polarizing plate 31 becomes −45°, whereby a left-handed circularly polarized light (left circularly polarized light) is obtained. In one embodiment of the present invention, either right circularly polarized light or left circularly polarized light can be used as long as combination with the characteristics of the reflective polarizing plate 36 described later is appropriate.

The half mirror 34 can have a structure of one embodiment of the present invention, where the adhesive 34c is provided between the dielectric multilayer films 34a and 34b. As the adhesive 34c, the above-described optical adhesive can be used.

Since the dielectric multilayer films 34a and 34b are each a multilayer film formed of extremely thin films, a support is needed for the formation. The support, which is not illustrated in FIG. 5, is preferably formed using a material having high transmittance of visible light and infrared light, and can be formed using glass, a resin, or the like. When the supports of the dielectric multilayer films 34a and 34b are formed using a resin material, the optical element can be lightweight.

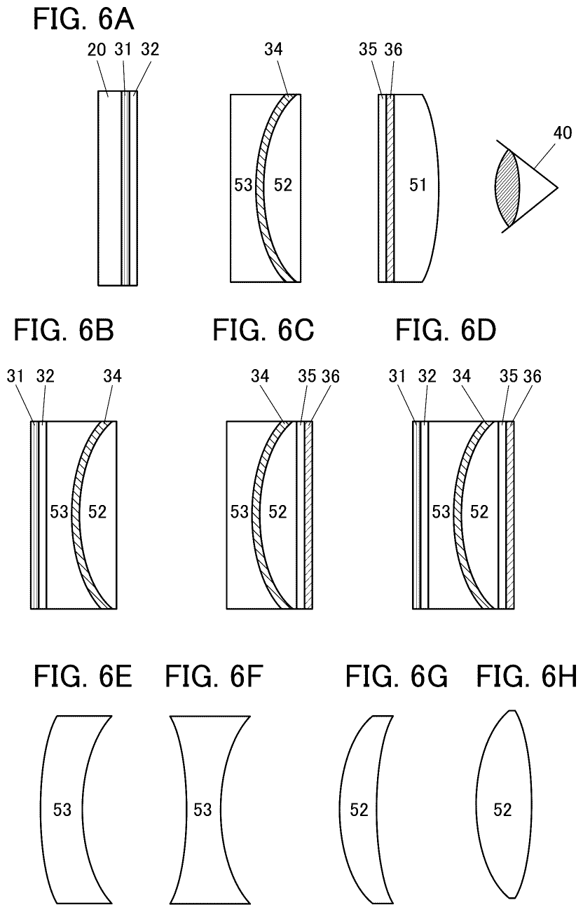

When the support has a curved surface, the half mirror 34 can have a curvature. For example, as illustrated in FIG. 6A, the optical component 53 having a plano-concave lens shape with a concave surface and the optical component 52 having a plano-convex lens shape with a concave surface can be used as the supports.

Here, a support of another component illustrated in FIG. 5 is also described. As the support of the linear polarizing plate 31 and the retardation plate 32 acting as a circularly polarizing plate, the display panel 20 can be used as illustrated in FIG. 6A, for example, and the linear polarizing plate 31 and the retardation plate 32 can be bonded to the display surface side.

As the support of the retardation plate 35 and the reflective polarizing plate 36 acting as a circularly polarizing plate, the lens 51 can be used as illustrated in FIG. 6A, for example, and the retardation plate 35 and the reflective polarizing plate 36 can be bonded to the light incident side of the lens 51.

Note that the mode of each support is not limited to the above. For example, as illustrated in FIG. 6B, the retardation plate 32 and the linear polarizing plate 31 can be bonded to the flat surface of the optical component 53 opposite to the concave surface thereof. As illustrated in FIG. 6C, the retardation plate 35 and the reflective polarizing plate 36 can be bonded to the flat surface of the optical component 52 opposite to the convex surface thereof. Alternatively, as illustrated in FIG. 6D, a structure combining FIG. 6B and FIG. 6C can be employed.

The modes of the optical components 53 and 52 are not limited to the above. For example, the optical component 53 can have a meniscus or biconcave lens shape as illustrated in FIGS. 6E and 6F. The optical component 52 can have a meniscus or biconvex lens shape as illustrated in FIGS. 6G and 6H.

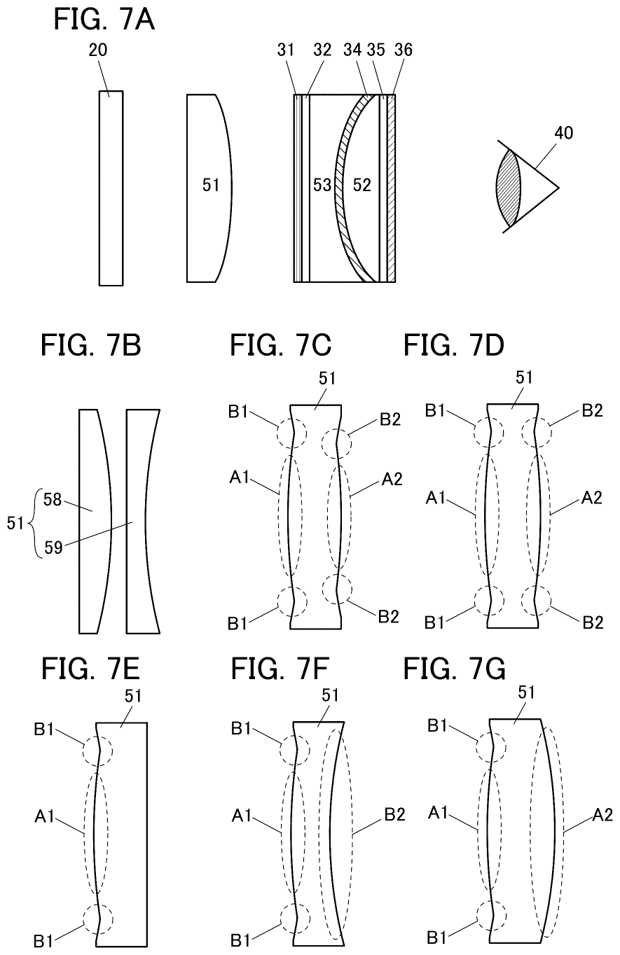

The lens 51 is not necessarily positioned as illustrated in FIG. 5, and can be positioned as illustrated in FIG. 7A, for example. Although FIG. 5 and FIG. 7A illustrate examples where the lens 51 is a plano-convex lens, one embodiment of the present invention is not limited thereto. For example, the lens 51 can be one selected from a biconvex lens, a plano-convex lens, a convex meniscus lens, a biconcave lens, a plano-concave lens, and a concave meniscus lens, or can have a structure combining a plurality of lenses as illustrated in FIG. 7B. FIG. 7B illustrates an example where the lens 51 is composed of two lenses: a lens 58 and a lens 59. The lens 51 can have a structure combining three or more lenses. The lens 51 is not limited to a spherical lens, and may be an aspherical lens. The use of combined lenses or an aspherical lens can reduce a variety of aberrations in the lens.

Alternatively, as illustrated in FIG. 7C, the lens 51 can be an aspherical singlet lens including regions A1 and A2 functioning as convex lenses and regions B1 and B2 functioning as part of concave lenses. Although FIG. 7C illustrates an example where the light incident side (the front side) of the lens 51 is provided with the regions A1 and B1 and the emission side (the back side) thereof is provided with the regions A2 and B2, the front and back sides may be reversed. In FIGS. 7D to 7G to be described later, there is no limitation on which side is front or back with respect to incident light.

FIG. 7C illustrates an example where the surface shapes on the light incident side and the emission side are different. Such a shape offers different effects of diffusion and light condensation in the central and peripheral portions, enabling accurate aberration correction. For example, by adjusting the curvatures of the front and back surfaces independently, the light-condensing effect can be obtained as a whole. That is, with the structure illustrated in FIG. 7C, the lens can function as a magnifying convex lens as a whole while having a correcting function owing to the region functioning as a concave lens.

Note that the effects required for the lens 51 vary and depend on the overall structure of the catadioptric system where the lens 51 is used. Accordingly, as illustrated in FIG. 7D, the shapes are sometimes the same on the light incident and emission sides. Alternatively, as illustrated in FIG. 7E, one of the surfaces through which light passes is flat in some cases. Alternatively, as illustrated in FIG. 7F, one of the surfaces through which light passes is sometimes provided with only the region B2 functioning as a concave lens. Alternatively, as illustrated in FIG. 7G, one of the surfaces through which light passes is sometimes provided with only the region A2 functioning as a convex lens.

The shape of the lens 51 can be determined in accordance with the desired effect, and a spherical lens can also be used. Depending on the prioritized effect, the lens 51 may be a combination of a plurality of lenses.

The focal length of the catadioptric system 30 can be determined by complex action of the power of the half mirror 34 acting as a concave mirror and the power of a lens provided in the catadioptric system 30. Thus, the shapes of the lens 51, the lens-like optical component 52, and the lens-like optical component 53 are preferably adjusted as appropriate so that a desired focal length can be obtained. Combinations of a plurality of supports with different shapes have the following features and can be selected as appropriate depending on the purpose.

As an indicator of field curvature, a Petzval sum is given, which is calculated from the refractive indices and focal lengths of the lenses. A Petzval sum of 0 results in a flat image surface, which is a desirable characteristic for a lens system. To achieve this, it is necessary to make either the refractive index or the focal length negative; however, since the refractive index cannot be negative, it is preferable to use a concave lens with a negative focal length. Thus, it can be said that one or more of the lens 51, the optical component 52, and the optical component 53 preferably have a concave lens shape in order to reduce the field curvature.

Refraction involves chromatic aberration, and combining positive and negative powers is effective for correcting the chromatic aberration. Even if the incident surface is flat, chromatic aberration occurs unless the rays are parallel. Thus, a combination of surfaces (convex and concave surfaces) that can correct the chromatic aberration is effective. Therefore, it can be said that the combination of the lens 51, the optical component 52, and the optical component 53 is preferably a combination of convex and concave lens shapes to reduce the chromatic aberration.

Simply put, a larger positive power allows for a shorter focal length and a smaller size of the entire optical system. Even when the half mirror provides most of the positive power, the focal length can be shortened if there is a convex surface. Thus, it can be said that one or more of the lens 51, the optical component 52, and the optical component 53 preferably have a convex lens shape to increase the positive power even slightly.

A catadioptric system of one embodiment of the present invention requires a polarizing plate and a retardation plate. These have a film-like shape, and flat bonding surfaces are advantageous in the process. Thus, in terms of easy manufacturing, it can be said that one or more of the lens 51, the optical component 52, and the optical component 53 preferably have a flat surface on the outer side.

In the catadioptric system 30, a lens made of a resin is desirably used for reduction in weight. On the other hand, a resin has a property of easily having birefringence. A substance with birefringence has varying refractive indices depending on the oscillation direction of polarized light, and thus transmits different polarized components at different speeds. Accordingly, the polarized components after passing through the substance have a phase difference, resulting in change in the polarizing state. In the catadioptric system, the change in the polarization state causes a ray deviated from a normal optical path. This ray enters the eye as stray light and is seen as a double or hazy image.

Although the relationship between the polarization state and the optical path is described later, for the above reasons, a lens on an optical path where polarized light goes back and forth is preferably formed using glass with almost no birefringence. In addition, since a human cannot recognize polarized light, the use of a resin lens with birefringence just before the eye 40 does not adversely affect the visibility of display.

Examples of the resin used for the lens include an acrylic resin, a polycarbonate resin, a polyester resin, and a cycloolefin resin, and these resins can be typically used as a material for the lens. Note that when formed using a material with sufficiently low birefringence, a resin lens can be used on an optical path where polarized light goes back and forth.

The retardation plate 35 has a function of reversibly converting linearly polarized light and circularly polarized light. Like the retardation plate 32, the retardation plate 35 can be a λ/4 plate (a quarter-wave plate).

The reflective polarizing plate 36 can reflect linearly polarized light whose oscillation direction coincides with the reflection axis, and can transmit linearly polarized light whose oscillation direction is orthogonal to the reflection axis. Note that an axis orthogonal to the reflection axis is referred to as a transmission axis. Note that the reflective polarizing plate 36 is placed to overlap with the linear polarizing plate 31 such that the transmission axis of the reflective polarizing plate 36 is orthogonal to the transmission axis of linear polarizing plate 31. Such arrangement can form an optical path of visible light involving reflection.

Next, optical paths of visible light emitted from the display panel 20 illustrated in FIG. 5 are described.

Part of light emitted from the display panel 20 passes through the linear polarizing plate 31 and the retardation plate 32, is semi-transmitted through the half mirror 34, passes through the retardation plate 35, and is reflected by the reflective polarizing plate 36. The light reflected by the reflective polarizing plate 36 passes through the retardation plate 35, and is semi-reflected by the half mirror 34. The light semi-reflected by the half mirror 34 passes through the retardation plate 35, the reflective polarizing plate 36, and the lens 51, and enters the eye 40 to form an image on the retina.

Reflection is repeated in the catadioptric system 30 in this manner, so that the optical path length can be ensured, whereby an optical system with a short focal length can be achieved.

Details of the polarized states in the optical paths are described. Light oscillating 360° all directions (non-polarized light) emitted from the display panel 20 enters the linear polarizing plate 31. The transmission axis of the linear polarizing plate 31 is 0°, and 0° linearly polarized light is extracted by the linear polarizing plate 31. Note that in the case where a liquid crystal panel is used as the display panel 20, the linear polarizing plate 31 can be used as one of a pair of polarizing plates included in the liquid crystal panel.

The 0° linearly polarized light extracted by the linear polarizing plate 31 is converted into left circularly polarized light (L) by the retardation plate 32. The left circularly polarized light (L) is semi-transmitted through the half mirror 34, enters the retardation plate 35, and is converted into 0° linearly polarized light. Although an example where light extracted by the retardation plate 32 is left circularly polarized light is described here, right circularly polarized light can also be used.

The 0° linearly polarized light extracted by the retardation plate 35 is reflected by the reflective polarizing plate 36 whose reflection axis is 0°, and the light enters the retardation plate 35 and is converted to left circularly polarized light (L). The left circularly polarized light (L) is semi-reflected by the half mirror 34 to be right circularly polarized light (R) with inverted chirality. The right circularly polarized light (R) enters the retardation plate 35 and is converted into 90° linearly polarized light. The 90° linearly polarized light passes through the reflective polarizing plate 36 whose transmission axis is 90° and the lens 51, and enters the eye 40.

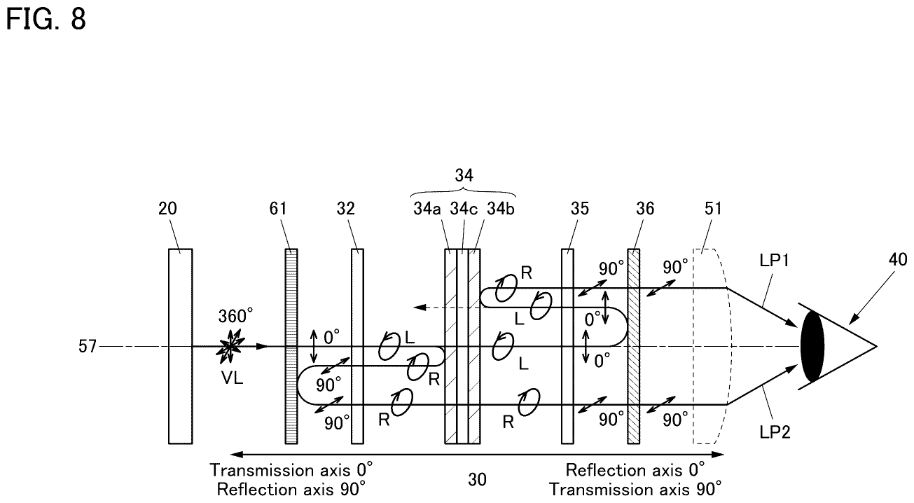

Note that the catadioptric system can have a structure illustrated in FIG. 8. In the structure illustrated in FIG. 8, light semi-reflected by the half mirror 34 first is reflected toward the eye 40 to approximately double the light utilization efficiency. The structure illustrated in FIG. 8 is different from the structure illustrated in FIG. 5 in that the linear polarizing plate 31 is replaced with a reflective polarizing plate 61 whose transmission axis is 0° and reflection axis is 90°. Thus, the structures illustrated in FIGS. 6A to 6H and FIGS. 7A to 7G can also be employed by replacing the linear polarizing plate 31 with the reflective polarizing plate 61.

In the structure illustrated in FIG. 8, in addition to an optical path LP1 with the above-described polarization state, an optical path LP2 of light semi-reflected by the half mirror 34 is also utilized. The left circularly polarized light (L) extracted by the retardation plate 32 is semi-reflected by the half mirror 34 to be the right circularly polarized light (R) with inverted chirality. The right circularly polarized light (R) enters the retardation plate 32 and is converted into 90° linearly polarized light. The 90° linearly polarized light is reflected by the reflective polarizing plate 61 whose reflection axis is 90°, enters the retardation plate 32, and is converted into right circularly polarized light (R). The right circularly polarized light (R) is semi-transmitted through the half mirror 34, enters the retardation plate 35, and is converted into 90° linearly polarized light. The 90° linearly polarized light passes through the reflective polarizing plate 36 whose transmission axis is 90° and the lens 51, and enters the eye 40.

As described above, when the catadioptric system has the structure in FIG. 8, both semi-transmitted light and semi-reflected light derived from light first entering the half mirror 34 can be effectively utilized, approximately doubling the light utilization efficiency.

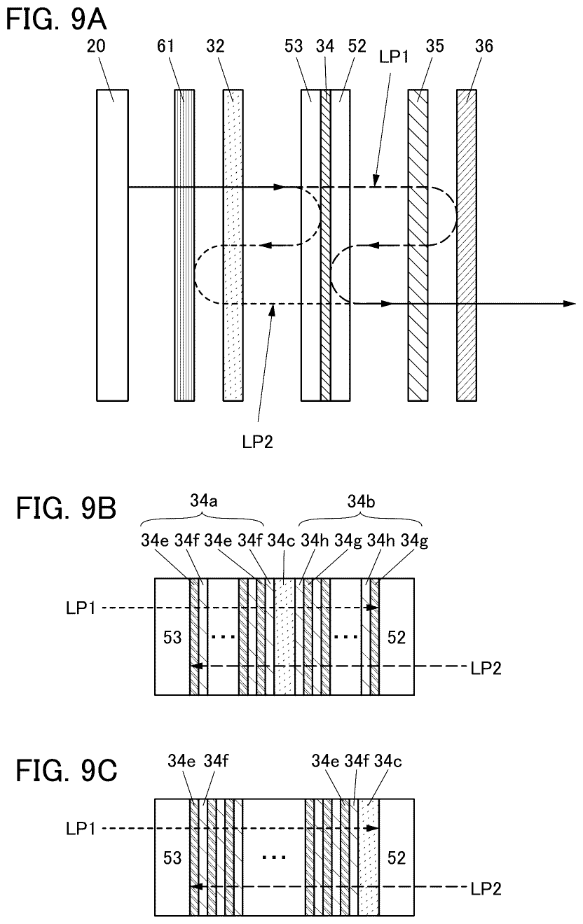

In the structure in FIG. 8, as illustrated in FIG. 9A, two optical paths of the optical path LP1 and the optical path LP2 are combined to match the image-formation position, approximately doubling the light utilization efficiency. This can be achieved when two split rays of light are refracted or reflected in a similar manner on the optical paths LP1 and LP2 and the optical paths finally converge. To obtain such an effect, the optical system is preferably symmetric about the half mirror 34.

Note that an optical system having a symmetrical shape refers to an optical system in which optical components are arranged so as to be plane symmetrical about a symmetry plane serving as a baseline and the plane-symmetric optical components have the same optical characteristics.

Although FIG. 9A illustrates that light is reflected by the surface of the half mirror 34, light is actually reflected by utilizing the entire half mirror 34 in the film thickness direction. In one embodiment of the present invention, for example, as illustrated in FIG. 9B, in the dielectric multilayer film 34a, the dielectric film 34e can be provided to include a region in contact with the optical component 53 and the dielectric film 34f can be provided to include a region in contact with the adhesive 34c. In the dielectric multilayer film 34b, the dielectric film 34g can be provided to include a region in contact with the optical component 52 and the dielectric film 34h can be provided to include a region in contact with the adhesive 34c. Here, when the optical components 53 and 52 are formed using the same material, the dielectric films 34e and 34g are formed using the same material, and the dielectric films 34f and 34h are formed using the same material, the components on the optical paths LP1 and LP2 can be strictly symmetric.

In the case where a multilayer film in which the dielectric films 34e and 34f are alternately stacked is provided on the optical component 53 and the multilayer film and the optical component 52 are bonded to each other with the adhesive 34c as in the conventional example illustrated in FIG. 9C, the components on the optical paths LP1 and LP2 are asymmetric. Thus, unless a component for correction is provided on either the optical path LP1 or the optical path LP2, the image-formation positions may be shifted in some cases.

Next, structures of a pixel and a light-emitting element of an organic EL panel that can be used as the display panel 20 will be described. The light-emitting element that can be used in one embodiment of the present invention preferably has a metal maskless (MML) structure where light-emitting layers are separately formed by a lithography process without using a fine metal mask (FMM). A light-emitting element having an MML structure can have a high aperture ratio and emit light with high luminance or low power consumption as compared with a light-emitting element manufactured using an FMM. The organic EL panel has a structure where a light-emitting element with an MML structure and a convex lens are combined to further increase the light extraction efficiency, and when the organic EL panel is combined with the catadioptric system 30 of one embodiment of the present invention, an XR device with high display quality and low power consumption can be formed.

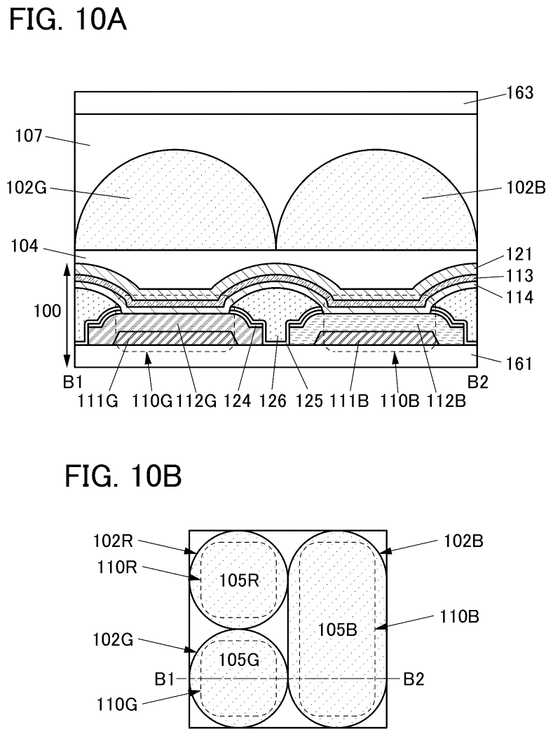

FIG. 10A is a cross-sectional view taken along the line B1-B2 in the top view of a pixel with S-stripe arrangement illustrated in FIG. 10B. The pixel includes the subpixel 105R, the subpixel 105G, and the subpixel 105B; however, the description of the subpixel 105R is omitted and the subpixel 105G and the subpixel 105B are described here. For the subpixel 105R, the description of the subpixel 105G and the subpixel 105B can be referred to.

Although an example employing S-stripe arrangement is described here, stripe arrangement, delta arrangement, zigzag arrangement, PenTile arrangement, diamond arrangement, or the like can be employed for the MML structure regardless of the shapes of subpixels.

A light-emitting element 110G included in the subpixel 105G and a light-emitting element 110B included in the subpixel 105B are provided over a substrate 161. The substrate 161 includes a component such as a pixel circuit in addition to a support.

As each of the light-emitting elements 110G and 110B, an organic light-emitting diode (OLED) or a quantum-dot light-emitting diode (QLED) is preferably used, for example. Examples of the light-emitting substance contained in the EL element include not only organic compounds but also inorganic compounds (e.g., quantum dot materials).

The light-emitting element 110G includes a pixel electrode 111G, an organic layer 112G, a common layer 114, and a common electrode 113. The light-emitting element 110B includes a pixel electrode 111B, an organic layer 112B, the common layer 114, and the common electrode 113. The common layer 114 and the common electrode 113 are shared by the light-emitting elements 110G and 110B.

The organic layer 112G of the light-emitting element 110G contains at least a light-emitting organic compound that emits green light. The organic layer 112B of the light-emitting element 110B contains at least a light-emitting organic compound that emits blue light. Each of the organic layers 112G and 112B can also be referred to as an EL layer, and includes at least a layer containing a light-emitting substance (a light-emitting layer).

Hereafter, the term “light-emitting element 110” is sometimes used to describe matters common to the light-emitting elements 110G and 110B. Similarly, in the description of matters common to components that are distinguished from each other using alphabets, such as the organic layers 112G and 112B, reference numerals without alphabets are sometimes used.

Each of the organic layer 112 and the common layer 114 can independently include one or more of an electron-injection layer, an electron-transport layer, a hole-injection layer, and a hole-transport layer. For example, the organic layer 112 can include a hole-injection layer, a hole-transport layer, a light-emitting layer, and an electron-transport layer that are stacked from the pixel electrode 111 side, and the common layer 114 can include an electron-injection layer.

The pixel electrode 111G and the pixel electrode 111B are provided for the respective light-emitting elements. Each of the common electrode 113 and the common layer 114 is provided as a continuous layer shared by the light-emitting elements. A conductive film having a property of transmitting visible light is used for either the pixel electrodes or the common electrode 113, and a reflective conductive film is used for the other. When the pixel electrodes are light-transmitting electrodes and the common electrode 113 is a reflective electrode, a bottom-emission display apparatus is obtained. Meanwhile, when the pixel electrodes are reflective electrodes and the common electrode 113 is a light-transmitting electrode, a top-emission display apparatus is obtained. Note that when both the pixel electrodes and the common electrode 113 are light-transmitting electrodes, a dual-emission display apparatus is obtained.

A protective layer 121 is provided over the common electrode 113 so as to cover the light-emitting elements 110G and 110B. The protective layer 121 has a function of preventing diffusion of impurities such as water into the light-emitting elements from above.

The pixel electrode 111 preferably has an end portion with a tapered shape. In the case where the pixel electrode 111 has an end portion with a tapered shape, the organic layer 112 provided along the end portion of the pixel electrode 111 can also have an inclined shape. When the end portion of the pixel electrode 111 has a tapered shape, coverage with the organic layer 112 provided to cover the end portion of the pixel electrode 111 can be improved. The side surface of the pixel electrode 111 having such a tapered shape is preferable because it allows a foreign matter (such as dust or particles) mixing during the manufacturing process to be easily removed by treatment such as cleaning.

In this specification and the like, a tapered shape indicates a shape such that at least part of a side surface of a structure is inclined relative to a substrate surface. For example, a tapered shape preferably includes a region where the angle formed between the inclined side surface and the substrate surface (such an angle is also referred to as a taper angle) is less than 90°.

The organic layer 112 is processed into an island shape using a resist mask formed by a lithography method, for example. Thus, the angle formed between the top surface and a side surface of an end portion of the organic layer 112 is approximately 90°. By contrast, an organic film formed using an FMM or the like has a thickness that tends to gradually decrease with decreasing distance to an end portion, and has a top surface forming a slope in an area extending from 1 μm to 10 μm from the end portion, for example; thus, such an organic film sometimes has a shape whose top surface and side surface cannot be easily distinguished from each other.

An insulating layer 124, an insulating layer 125, and a resin layer 126 are included between two adjacent light-emitting elements.

Between two adjacent light-emitting elements, a side surface of the organic layer 112 of one light-emitting element faces a side surface of the organic layer 112 of the other light-emitting element with the resin layer 126 therebetween. The resin layer 126 is positioned between two adjacent light-emitting elements so as to fill the region between the end portions of their organic layers 112 and the region between the two organic layers 112. The resin layer 126 has a top surface with a smooth convex shape. The top surface of the resin layer 126 is covered with the common layer 114 and the common electrode 113.

The resin layer 126 functions as a planarization film that fills a step between two adjacent light-emitting elements. Providing the resin layer 126 can prevent a phenomenon in which the common electrode 113 is divided by a step at an end portion of the organic layer 112 (also referred to as disconnection) from occurring and the common electrode over the organic layer 112 from being insulated.

The organic layers 112 included in the adjacent light-emitting elements 110 are insulated from each other by the resin layer 126. Accordingly, a leakage current through the organic layers 112 between the adjacent light-emitting elements can be reduced, so that unnecessary light emission due to crosstalk can be inhibited. Accordingly, the color reproducibility of the display apparatus can be improved.

An insulating layer containing an organic material can be suitably used as the resin layer 126. Examples of the material used for the resin layer 126 include an acrylic resin, a polyimide resin, an epoxy resin, an imide resin, a polyamide resin, a polyimide-amide resin, a silicone resin, a siloxane resin, a benzocyclobutene-based resin, a phenol resin, and precursors of these resins.

The resin layer 126 may be formed using an organic material such as polyvinyl alcohol (PVA), polyvinyl butyral, polyvinylpyrrolidone, polyethylene glycol, polyglycerin, pullulan, water-soluble cellulose, or an alcohol-soluble polyamide resin.

A photosensitive resin can also be used for the resin layer 126. A photoresist may be used for the photosensitive resin. As the photosensitive resin, a positive photosensitive material or a negative photosensitive material can be used.

The resin layer 126 may contain a material absorbing visible light. For example, the resin layer 126 itself may be made of a material absorbing visible light, or the resin layer 126 may contain a pigment absorbing visible light. For example, the resin layer 126 can be formed using a resin that can be used as a color filter transmitting red, blue, or green light and absorbing light of the other colors; or a resin that contains carbon black as a pigment and functions as a black matrix.

When the resin layer 126 absorbs light emitted from the light-emitting element in an oblique direction, light leakage (stray light) from the light-emitting element to the adjacent light-emitting element through the resin layer 126 can be inhibited. Thus, the display quality of the display apparatus can be improved.

The insulating layer 125 is provided in contact with the side surface of the organic layer 112. Moreover, the insulating layer 125 is provided to cover a top end portion of the organic layer 112. Part of the insulating layer 125 is in contact with the top surface of the substrate 161.

The insulating layer 125 is positioned between the resin layer 126 and the organic layer 112 to function as a protective film for preventing contact between the resin layer 126 and the organic layer 112. When the organic layer 112 and the resin layer 126 are in contact with each other, the organic layer 112 might be dissolved in an organic solvent or the like used in formation of the resin layer 126. In view of this, the insulating layer 125 is provided between the organic layer 112 and the resin layer 126 to protect the side surface of the organic layer 112.

The insulating layer 125 can be an insulating layer containing an inorganic material. As the insulating layer 125, an inorganic insulating film such as an oxide insulating film, a nitride insulating film, an oxynitride insulating film, or a nitride oxide insulating film can be used, for example. The insulating layer 125 may have a single-layer structure or a stacked-layer structure. Examples of the oxide insulating film include a silicon oxide film, an aluminum oxide film, a magnesium oxide film, an indium gallium zinc oxide film, a gallium oxide film, a germanium oxide film, an yttrium oxide film, a zirconium oxide film, a lanthanum oxide film, a neodymium oxide film, a hafnium oxide film, and a tantalum oxide film. Examples of the nitride insulating film include a silicon nitride film and an aluminum nitride film. Examples of the oxynitride insulating film include a silicon oxynitride film and an aluminum oxynitride film. Examples of the nitride oxide insulating film include a silicon nitride oxide film and an aluminum nitride oxide film. In particular, when a metal oxide film such as an aluminum oxide film or a hafnium oxide film or an inorganic insulating film such as a silicon nitride film or a silicon oxide film that is formed by an atomic layer deposition (ALD) method is used for the insulating layer 125, the insulating layer 125 has a small number of pin holes and excels in a function of protecting the EL layer.

Note that in this specification and the like, oxynitride refers to a material that contains more oxygen than nitrogen, and nitride oxide refers to a material that contains more nitrogen than oxygen. For example, silicon oxynitride refers to a material that contains more oxygen than nitrogen, and silicon nitride oxide refers to a material that contains more nitrogen than oxygen.

The insulating layer 125 can be formed by a sputtering method, a chemical vapor deposition (CVD) method, a pulsed laser deposition (PLD) method, an ALD method, or the like. The insulating layer 125 is preferably formed by an ALD method achieving good coverage.

Between the insulating layer 125 and the resin layer 126, a reflective film (e.g., a metal film containing one or more of silver, palladium, copper, titanium, aluminum, and the like) may be provided to reflect light that is emitted from the light-emitting layer. In this case, the light extraction efficiency can be increased.

Part of a protective layer (also referred to as a mask layer or a sacrificial layer) for protecting the organic layer 112 during etching of the organic layer 112 survives the etching to become the insulating layer 124. For the insulating layer 124, the material that can be used for the insulating layer 125 can be used. In particular, the insulating layer 124 and the insulating layer 125 are preferably formed using the same material, in which case an apparatus or the like for processing can be used in common.

In particular, a metal oxide film such as an aluminum oxide film or a hafnium oxide film or an inorganic insulating film such as a silicon nitride film or a silicon oxide film that is formed by an ALD method have a small number of pinholes, and thus excel in the function of protecting the EL layer and are preferably used for the insulating layer 125 and the insulating layer 124.

The protective layer 121 can have, for example, a single-layer structure or a stacked-layer structure at least including an inorganic insulating film. Examples of the inorganic insulating film include oxide films and nitride films such as a silicon oxide film, a silicon oxynitride film, a silicon nitride oxide film, a silicon nitride film, an aluminum oxide film, an aluminum oxynitride film, and a hafnium oxide film. Alternatively, a semiconductor material or a conductive material such as an indium gallium oxide, an indium zinc oxide, an indium tin oxide, or an indium gallium zinc oxide may be used for the protective layer 121.

An insulating layer 104 is provided over the protective layer 121 and functions as a planarization layer. The insulating layer 104 can be formed using a material that can be used for the resin layer 126 or a material that can be used for the insulating layer 125, for example. Note that the insulating layer 104 is sometimes not provided.

A plano-convex lens 102 (lenses 102G and 102B) is provided over the insulating layer 104 so as to overlap with the light-emitting element 110. An insulating layer 107 is provided over the lens 102. The lens 102 and the light-emitting element 110 are provided as a pair. Specifically, the lenses 102R, 102G, and 102B are provided to overlap with the light-emitting elements 110R, 110G, and 110B, respectively. In other words, one lens 102 is provided for one subpixel.

The lens 102 is provided above the light-emitting element 110 (in the direction in which light is emitted). Since the lens 102 has a convex shape, the lens 102 can lead light to be converged. That is, divergence of the light emitted from the light-emitting element can be inhibited, so that the light extraction efficiency of the display apparatus can be increased. The lens 102 can be formed using a material similar to that for the resin layer 126 in a similar step.

The insulating layer 107 provided over the lens 102 is an adhesive layer provided between the lens 102 and a substrate 163 and is preferably formed using an organic material. For example, it is possible to use an optical adhesive or the like having a refractive index close to that of the glass or the film that can be used as the substrate 163.

The light extraction efficiency of the display panel can be increased by providing the lens, and it is also effective to use a light-emitting element with higher emission efficiency to increase the front luminance of the display panel. In principle, the luminance of a tandem organic EL element increases as the number of stacked units increases at the same current density; the luminance of a two-unit tandem organic EL element can be twice that of a single organic EL element.

The lifetime of an organic EL element depends on the current density; thus, at the same current density, a tandem organic EL element has an equivalent lifetime to a single organic EL element even when having a doubled luminance. That is, a tandem organic EL element can be regarded as being effective in increasing the luminance and the reliability of an organic EL element.

The above is the description of the structure examples of the light-emitting elements and the vicinity thereof.

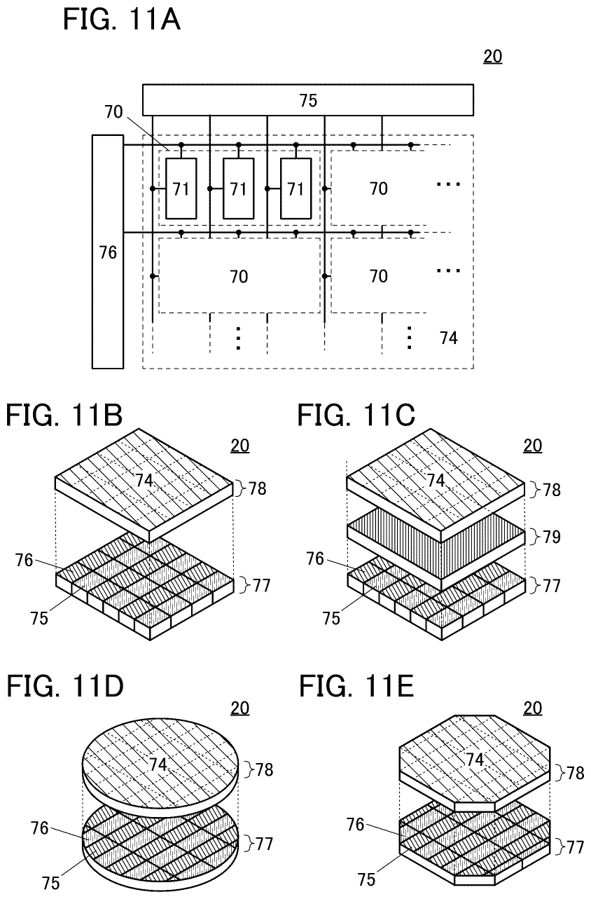

FIG. 11A is a block diagram illustrating the display panel 20 of one embodiment of the present invention. The display panel 20 includes a pixel array 74, a circuit 75, and a circuit 76. The pixel array 74 includes pixels 70 arranged in a column direction and a row direction.

The pixel 70 can include a plurality of subpixels 71. The subpixel 71 has a function of emitting light for display. When colors of R (red), G (green), B (blue), and the like are assigned to light emitted from the subpixels 71, full-color display can be performed.

The subpixel 71 includes a light-emitting device that emits non-polarized visible light. As the light-emitting device, an EL element such as an OLED or a QLED is preferably used.

Examples of a light-emitting substance contained in the EL element include a substance exhibiting fluorescence (a fluorescent material), a substance exhibiting phosphorescence (a phosphorescent material), a substance exhibiting thermally activated delayed fluorescence (a thermally activated delayed fluorescent (TADF) material), and an inorganic compound (e.g., a quantum dot material). In addition, an LED such as a micro LED can be also used as the light-emitting device.

The circuits 75 and 76 are driver circuits for driving the subpixel 71. The circuit 75 can have a function of a source driver circuit, and the circuit 76 can have a function of a gate driver circuit. A shift register circuit or the like can be used as each of the circuits 75 and 76, for example.

Note that the display panel 20 may be divided into a plurality of regions horizontally and vertically, and pixels may be driven for each divided region.

For example, as illustrated in FIG. 11B, each of the circuits 75 and 76 can be divided and arranged under the pixel array 74. In this case, the display panel 20 has a stacked-layer structure of a layer 77 and a layer 78, a plurality of the circuits 75 and a plurality of the circuits 76 are provided in the layer 77, and the pixel array 74 is provided in the layer 78 to overlap with the circuits 75 and 76.

In addition, when the circuits 75 and 76 are separately arranged, the pixel array 74 can be driven on the divided region basis. For example, the pixel array 74 can be operated at different frame rates from region to region. The pixel array 74 can perform display at different resolutions from region to region, which allows application to foveated rendering.

In addition, when the driver circuits are provided below the pixel array 74, wiring length can be shortened and wiring capacitance can be reduced. Accordingly, a display apparatus capable of high-speed operation with low power consumption can be provided. In addition, the display panel 20 can have a narrow bezel.

The layouts and areas of the circuit 75 and the circuit 76 illustrated in FIG. 11B are examples, and can be changed as appropriate. In addition, part of each of the circuits 75 and 76 can be formed in the same layer as the pixel array 74. Furthermore, a circuit such as a memory circuit, an arithmetic circuit, or a communication circuit may be provided in the layer 77.

In this structure, for example, the layer 77 can be provided on a single crystal silicon substrate, the circuit 75 and the circuit 76 can be formed with transistors containing silicon in channel formation regions (hereinafter referred to as Si transistors), and pixel circuits included in the pixel array 74 provided in the layer 78 can be formed with transistors containing a metal oxide in channel formation regions (hereinafter referred to as OS transistors). An OS transistor can be formed with a thin film and can be formed to be stacked over a Si transistor.

Note that a structure illustrated in FIG. 11C where a layer 79 including OS transistors is provided between the layer 77 and the layer 78 may be employed. In the layer 79, OS transistors constituting part of the pixel circuits included in the pixel array 74 can be provided. Alternatively, OS transistors constituting part of the circuit 75 and the circuit 76 can be provided in the layer 79. Alternatively, OS transistors constituting part of the circuits that can be provided in the layer 77, such as a memory circuit, an arithmetic circuit, and a communication circuit, can be provided in the layer 79.

The top-view shape of the display panel 20 is not limited to a rectangle and may be a circle as illustrated in FIG. 11D. Alternatively, polygons such as octagons illustrated in FIG. 11E may be employed.

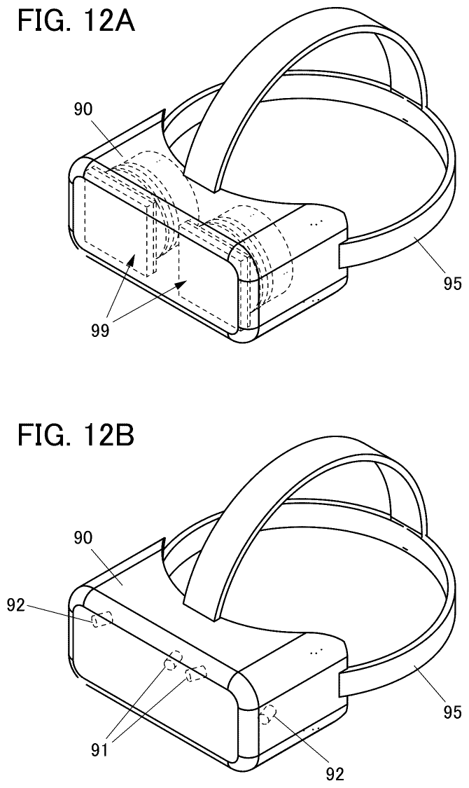

FIG. 12A is a diagram illustrating an example of a glasses-type device including the display apparatus and the optical device that are embodiments of the present invention. Here, a combination of the display panel 20 and the catadioptric system 30 illustrated in FIG. 5 or FIG. 8 is shown as the display unit 99 by a dashed line.

A user can see an image displayed on the display panel 20 by bringing his/her eyes closer to the vicinity of the catadioptric system 30 provided on the display surface side of the display panel 20. The user sees the image with a viewing angle widened by the catadioptric system 30, and thus can feel a sense of immersion and a realistic sensation.

The two display units 99 are incorporated in the housing 90. One of the display units 99 is for a right eye, the other is for a left eye, and each of the display units 99 displays an image using parallax, offering the stereoscopic effect of the image.

The housing 90 or a support 95 may be provided with an input terminal and an output terminal. To the input terminal, a cable for supplying a video signal from a video output device or the like, power for charging the battery, and the like can be connected. The output terminal can function as, for example, an audio output terminal to which earphones, headphones, or the like can be connected. Note that in the case where audio data can be output by wireless communication or sound is output from an external video output device, the audio output terminal is not necessarily provided.

A wireless communication module, a memory module, and the like may be provided inside the housing 90 or the support 95. A content to be watched can be downloaded via wireless communication using the wireless communication module and stored in the memory module. In this manner, the user can watch the downloaded content offline.

As illustrated in FIG. 12B, a gaze sensor 91 may be provided in the housing 90. The gaze sensor 91 uses light emitted from a light source 92 provided in the housing 90 and detects the gaze by reading a change of reflected light due to the movement of the iris. As the light emitted from the light source 92, near-infrared light with extremely low luminosity is preferably used. For example, operation buttons for power-on, power-off, sleep, volume control, channel change, menu display, selection, decision, and back, and operation buttons for play, stop, pause, fast forward, and rewinding of moving images are displayed and visually recognized, whereby the operations can be performed. The user's fatigue level may be detected from the number of blinks or the like and an alert may be displayed, for example.

With use of the display apparatus of one embodiment of the present invention for the glasses-type device, an electronic device with low power consumption and high reliability is achieved.

At least part of this embodiment can be implemented in combination with any of the other embodiments described in this specification as appropriate.

### Embodiment 2

In this embodiment, structure examples of display panels which can be used for a display apparatus of one embodiment of the present invention will be described.

The display panel of this embodiment has high resolution, and is particularly suitably used for display portions of wearable devices capable of being worn on a head, such as a VR device (e.g., a head-mounted display) and a glasses-type AR device.

### [Display Module]

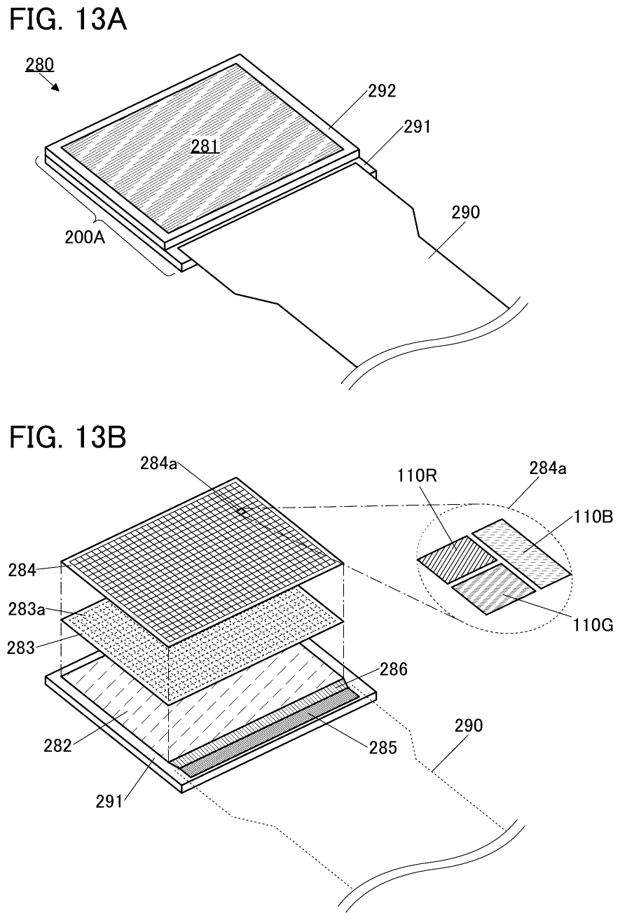

FIG. 13A is a perspective view of a display module 280. The display module 280 includes a display panel 200A and an FPC 290. Note that the display panel included in the display module 280 is not limited to the display panel 200A and may be any of display panels 200B to 200F to be described later.

The display module 280 includes a substrate 291 and a substrate 292. The display module 280 includes a display portion 281. The display portion 281 is a region where an image is displayed.

FIG. 13B is a perspective view schematically illustrating the structure on the substrate 291 side. Over the substrate 291, a circuit portion 282, a pixel circuit portion 283 over the circuit portion 282, and a pixel portion 284 over the pixel circuit portion 283 are stacked. In addition, a terminal portion 285 for connection to the FPC 290 is provided in a portion over the substrate 291 that does not overlap with the pixel portion 284. The terminal portion 285 and the circuit portion 282 are connected to each other through a wiring portion 286 formed of a plurality of wirings.

The pixel portion 284 includes a plurality of pixels 284a arranged periodically. An enlarged view of one pixel 284a is illustrated on the right side in FIG. 13B. The pixel 284a includes a light-emitting element 110R emitting red light, the light-emitting element 110G emitting green light, and the light-emitting element 110B emitting blue light.

The pixel circuit portion 283 includes a plurality of pixel circuits 283a arranged periodically. One pixel circuit 283a controls light emission from three light-emitting devices included in one pixel 284a. One pixel circuit 283a may include three circuits each of which controls light emission from one light-emitting device. For example, the pixel circuit 283a can include at least one selection transistor, one current control transistor (driving transistor), and a capacitor for one light-emitting device. In this case, a gate signal is input to a gate of the selection transistor, and a source signal is input to a source of the selection transistor. Thus, an active matrix display panel is achieved.

The circuit portion 282 includes a circuit for driving the pixel circuits 283a in the pixel circuit portion 283. For example, the circuit portion 282 preferably includes one or both of a gate line driver circuit and a source line driver circuit. The circuit portion 282 may also include at least one of an arithmetic circuit, a memory circuit, a power supply circuit, and the like. A transistor included in the circuit portion 282 may constitute part of the pixel circuit 283a. That is, the pixel circuit 283a may be constituted by a transistor included in the pixel circuit portion 283 and a transistor included in the circuit portion 282.

The FPC 290 functions as a wiring for supplying a video signal, a power supply potential, or the like to the circuit portion 282 from the outside. An IC may be mounted on the FPC 290.

The display module 280 can have a structure where one or both of the pixel circuit portion 283 and the circuit portion 282 are stacked below the pixel portion 284; hence, the aperture ratio (effective display area ratio) of the display portion 281 can be significantly high. For example, the aperture ratio of the display portion 281 can be higher than or equal to 40% and lower than 100%, preferably higher than or equal to 50% and lower than or equal to 95%, further preferably higher than or equal to 60% and lower than or equal to 95%. Furthermore, the pixels 284a can be arranged extremely densely and thus the display portion 281 can have significantly high pixel density. For example, the pixels 284a are preferably arranged in the display portion 281 with a pixel density higher than or equal to 2000 ppi, preferably higher than or equal to 3000 ppi, further preferably higher than or equal to 5000 ppi, still further preferably higher than or equal to 6000 ppi, and lower than or equal to 20000 ppi or lower than or equal to 30000 ppi.

Such a display module 280 has extremely high resolution, and thus can be suitably used for a device for VR such as a head-mounted display or a glasses-type device for AR. For example, even in the case of a structure where the display portion of the display module 280 is seen through a lens, pixels of the extremely-high-resolution display portion 281 included in the display module 280 are prevented from being recognized when the display portion is enlarged by the lens, so that display providing a high sense of immersion can be performed. Without being limited thereto, the display module 280 can be suitably used for electronic devices including a relatively small display portion. For example, the display module 280 can be suitably used in a display portion of a wearable electronic device, such as a wrist watch.

### [Display Panel 200A]

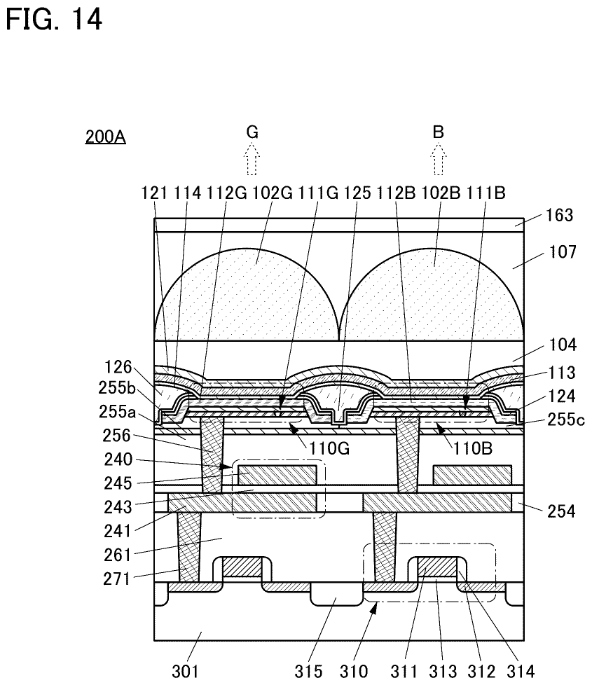

The display panel 200A illustrated in FIG. 14 includes a substrate 301, the light-emitting elements 110R, 110G, and 110B, a capacitor 240, and a transistor 310.

The substrate 301 corresponds to the substrate 291 in FIGS. 13A and 13B.

The transistor 310 includes a channel formation region in the substrate 301. As the substrate 301, a semiconductor substrate such as a single crystal silicon substrate can be used, for example. The transistor 310 includes part of the substrate 301, a conductive layer 311, a low-resistance region 312, an insulating layer 313, and an insulating layer 314. The conductive layer 311 functions as a gate electrode. The insulating layer 313 is positioned between the substrate 301 and the conductive layer 311 and functions as a gate insulating layer. The low-resistance region 312 is a region where the substrate 301 is doped with an impurity, and functions as one of a source and a drain. The insulating layer 314 is provided to cover the side surface of the conductive layer 311.

An element isolation layer 315 is provided between two adjacent transistors 310 to be embedded in the substrate 301.

An insulating layer 261 is provided to cover the transistor 310, and the capacitor 240 is provided over the insulating layer 261.

The capacitor 240 includes a conductive layer 241, a conductive layer 245, and an insulating layer 243 between the conductive layers 241 and 245. The conductive layer 241 functions as one electrode of the capacitor 240, the conductive layer 245 functions as the other electrode of the capacitor 240, and the insulating layer 243 functions as a dielectric of the capacitor 240.

The conductive layer 241 is provided over the insulating layer 261 and is embedded in an insulating layer 254. The conductive layer 241 is connected to one of a source and a drain of the transistor 310 through a plug 271 embedded in the insulating layer 261. The insulating layer 243 is provided to cover the conductive layer 241. The conductive layer 245 is provided in a region overlapping with the conductive layer 241 with the insulating layer 243 therebetween.

An insulating layer 255a is provided to cover the capacitor 240, an insulating layer 255b is provided over the insulating layer 255a, and an insulating layer 255c is provided over the insulating layer 255b.

An inorganic insulating film can be suitably used as each of the insulating layers 255a, 255b, and 255c. For example, it is preferable that a silicon oxide film be used as the insulating layers 255a and 255c and a silicon nitride film be used as the insulating layer 255b. This enables the insulating layer 255b to function as an etching protective film. Although this embodiment describes an example where the insulating layer 255c is partly etched and a depressed portion is formed, the depressed portion is not necessarily provided in the insulating layer 255c.

The light-emitting element 110G and the light-emitting element 110B are provided over the insulating layer 255c. Embodiment 1 can be referred to for the structures of the light-emitting element 110G and the light-emitting element 110B.

In the display panel 200A, since the light-emitting devices of different colors are separately formed, the difference between the chromaticity at low luminance emission and that at high luminance emission is small. Furthermore, since the organic layers 112G and 112B are separated from each other, generation of crosstalk between adjacent subpixels can be inhibited while the display panel has high resolution. Accordingly, the display panel can have high resolution and high display quality.

In the region between adjacent light-emitting elements, the insulating layer 125 and the resin layer 126 are provided.

The pixel electrodes 111G and 111B are each connected to one of the source and the drain of the transistor 310 through a plug 256 embedded in the insulating layers 255a, 255b, and 255c, the conductive layer 241 embedded in the insulating layer 254, and the plug 271 embedded in the insulating layer 261. The top surface of the insulating layer 255c and the top surface of the plug 256 are level with or substantially level with each other. Any of a variety of conductive materials can be used for the plugs.

The protective layer 121 is provided over the light-emitting elements 110G and 110B. The insulating layer 104 and the lens 102 (lenses 102G and 102B) are provided over the protective layer 121. The substrate 163 is attached over the lens 102 with the insulating layer 107 functioning as an adhesive layer.

An insulating layer covering an end portion of the top surface of the pixel electrode 111 is not provided between two adjacent pixel electrodes 111. Thus, the interval between adjacent light-emitting elements can be extremely short. Accordingly, the display panel can have high resolution or high definition.

### [Display Panel 200B]

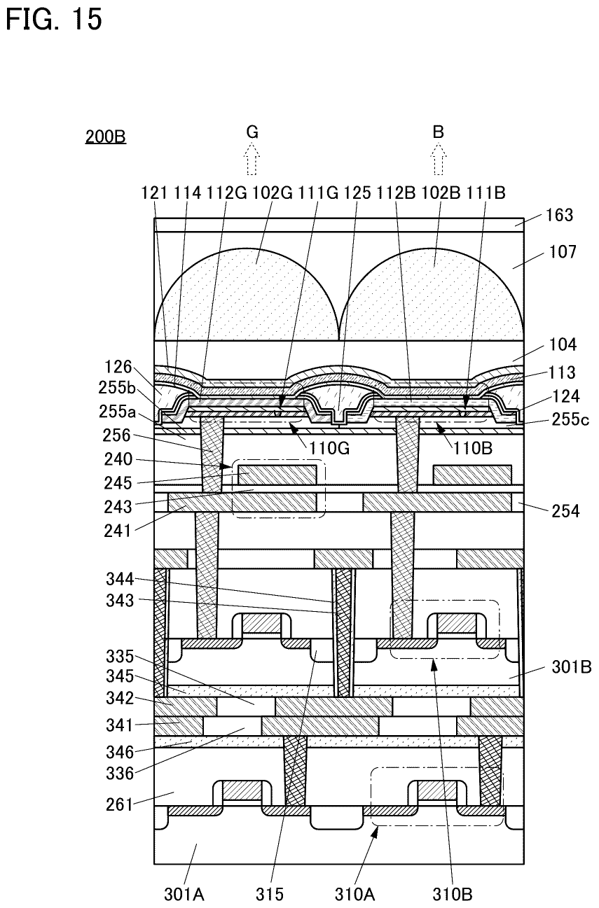

The display panel 200B illustrated in FIG. 15 has a structure where a transistor 310A and a transistor 310B each having a channel formed in a semiconductor substrate are stacked. Note that in the following description of display panels, the description of portions similar to those of the above-described display panel may be omitted.

In the display panel 200B, a substrate 301B provided with the transistor 310B, the capacitor 240, and the light-emitting devices is attached to a substrate 301A provided with the transistor 310A.

Here, an insulating layer 345 is provided on the bottom surface of the substrate 301B. An insulating layer 346 is provided over the insulating layer 261 over the substrate 301A. The insulating layers 345 and 346 function as protective layers and can inhibit diffusion of impurities into the substrates 301B and 301A. As the insulating layers 345 and 346, an inorganic insulating film that can be used as the protective layer 121 can be used.

The substrate 301B is provided with a plug 343 penetrating the substrate 301B and the insulating layer 345. An insulating layer 344 functioning as a protective layer is preferably provided to cover the side surface of the plug 343.

A conductive layer 342 is provided under the insulating layer 345 on the rear surface of the substrate 301B. The conductive layer 342 is embedded in an insulating layer 335. The bottom surfaces of the conductive layer 342 and the insulating layer 335 are planarized. The conductive layer 342 is connected to the plug 343.

A conductive layer 341 is provided over the insulating layer 346 over the substrate 301A. The conductive layer 341 is embedded in an insulating layer 336. The top surfaces of the conductive layer 341 and the insulating layer 336 are planarized.

The conductive layers 341 and 342 are preferably formed using the same conductive material. For example, it is possible to use a metal film containing an element selected from Al, Cr, Cu, Ta, Ti, Mo, and W, or a metal nitride film containing any of the above elements as a component (a titanium nitride film, a molybdenum nitride film, or a tungsten nitride film). Copper is particularly preferably used for the conductive layers 341 and 342. In that case, it is possible to employ copper-to-copper (Cu-to-Cu) direct bonding (a technique for achieving electrical continuity by connecting copper (Cu) pads).

### [Display Panel 200C]

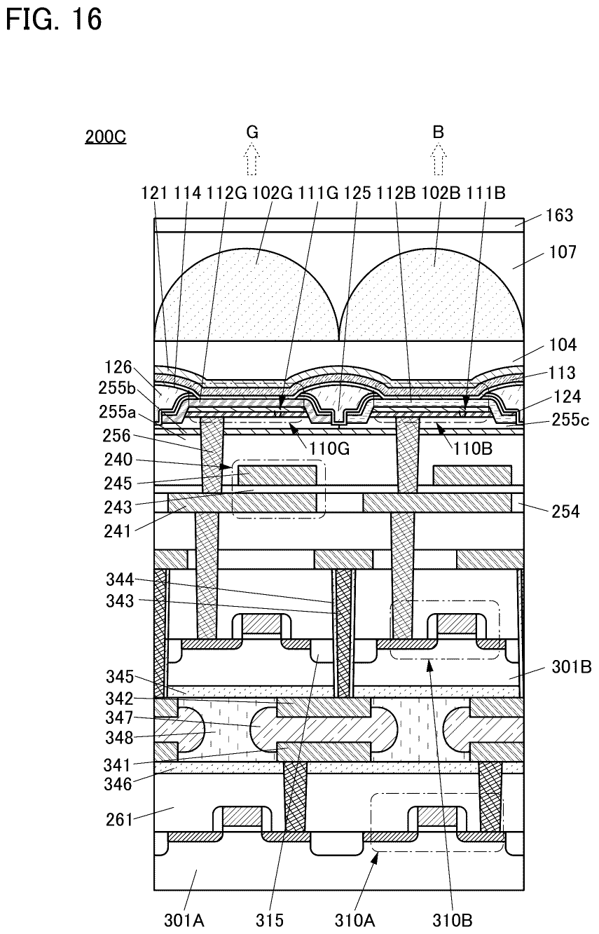

The display panel 200C illustrated in FIG. 16 has a structure where the conductive layers 341 and 342 are bonded to each other with a bump 347.

As illustrated in FIG. 16, providing the bump 347 between the conductive layers 341 and 342 enables the conductive layers 341 and 342 to be connected to each other. The bump 347 can be formed using a conductive material containing gold (Au), nickel (Ni), indium (In), tin (Sn), or the like, for example. As another example, solder may be used for the bump 347. An adhesive layer 348 may be provided between the insulating layers 345 and 346. In the case where the bump 347 is provided, the insulating layers 335 and 336 may be omitted.

### [Display Panel 200D]

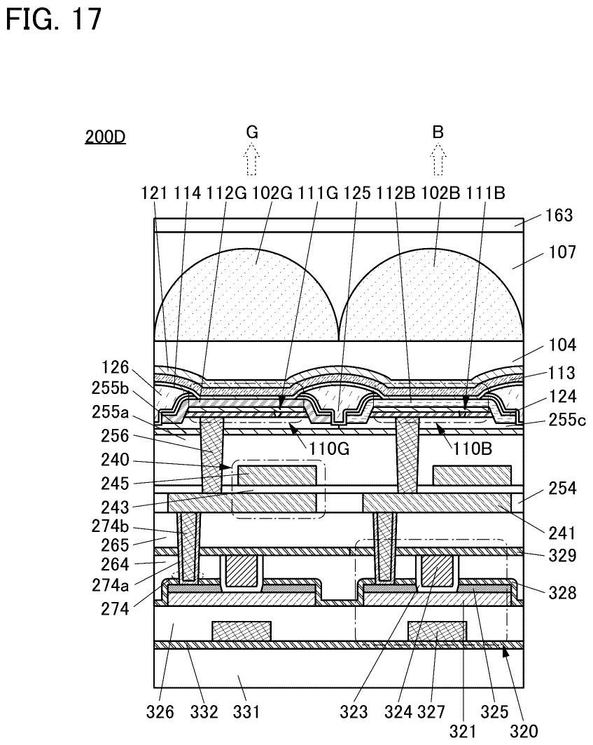

The display panel 200D illustrated in FIG. 17 is different from the display panel 200A mainly in a structure of a transistor.

A transistor 320 is a transistor containing a metal oxide (also referred to as an oxide semiconductor) in a semiconductor layer where a channel is formed (i.e., an OS transistor).

The transistor 320 includes a semiconductor layer 321, an insulating layer 323, a conductive layer 324, a pair of conductive layers 325, an insulating layer 326, and a conductive layer 327.

A substrate 331 corresponds to the substrate 291 in FIGS. 13A and 13B.

An insulating layer 332 is provided over the substrate 331. The insulating layer 332 functions as a barrier layer that prevents diffusion of impurities such as water or hydrogen from the substrate 331 into the transistor 320 and release of oxygen from the semiconductor layer 321 to the insulating layer 332 side. As the insulating layer 332, for example, a film in which hydrogen or oxygen is less likely to diffuse than in a silicon oxide film, such as an aluminum oxide film, a hafnium oxide film, or a silicon nitride film can be used.

The conductive layer 327 is provided over the insulating layer 332, and the insulating layer 326 is provided to cover the conductive layer 327. The conductive layer 327 functions as a first gate electrode of the transistor 320, and part of the insulating layer 326 functions as a first gate insulating layer. An oxide insulating film such as a silicon oxide film is preferably used as at least part of the insulating layer 326 which is in contact with the semiconductor layer 321. The top surface of the insulating layer 326 is preferably planarized.

The semiconductor layer 321 is provided over the insulating layer 326. A metal oxide film having semiconductor characteristics (also referred to as an oxide semiconductor film) is preferably used as the semiconductor layer 321. The pair of conductive layers 325 is provided over and in contact with the semiconductor layer 321, and functions as a source electrode and a drain electrode.

An insulating layer 328 is provided to cover the top and side surfaces of the pair of conductive layers 325, the side surface of the semiconductor layer 321, and the like, and an insulating layer 264 is provided over the insulating layer 328. The insulating layer 328 functions as a barrier layer that prevents diffusion of impurities such as water or hydrogen from the insulating layer 264 and the like into the semiconductor layer 321 and release of oxygen from the semiconductor layer 321. As the insulating layer 328, an insulating film similar to the insulating layer 332 can be used.

An opening reaching the semiconductor layer 321 is provided in the insulating layers 328 and 264. The insulating layer 323 that is in contact with the top surface of the semiconductor layer 321 and the conductive layer 324 are embedded in the opening. The conductive layer 324 functions as a second gate electrode, and the insulating layer 323 functions as a second gate insulating layer.

The top surfaces of the conductive layer 324, the insulating layer 323, and the insulating layer 264 are planarized to be level with or substantially level with each other, and insulating layers 329 and 265 are provided to cover these layers.

The insulating layers 264 and 265 function as interlayer insulating layers. The insulating layer 329 functions as a barrier layer that prevents diffusion of impurities such as water or hydrogen from the insulating layer 265 or the like to the transistor 320. As the insulating layer 329, an insulating film similar to the insulating layers 328 and 332 can be used.

A plug 274 connected to one of the pair of conductive layers 325 is provided to be embedded in the insulating layers 265, 329, and 264. Here, the plug 274 preferably includes a conductive layer 274a covering the side surface of an opening formed in the insulating layers 265, 329, 264, and 328 and part of the top surface of the conductive layer 325, and a conductive layer 274b in contact with the top surface of the conductive layer 274a. For the conductive layer 274a, a conductive material in which hydrogen and oxygen are less likely to diffuse is preferably used.

There is no particular limitation on the structure of the transistors included in the display panel of this embodiment. For example, a planar transistor, a staggered transistor, or an inverted staggered transistor can be used. A top-gate transistor or a bottom-gate transistor can be used. Alternatively, gates may be provided above and below a semiconductor layer where a channel is formed.

The structure where the semiconductor layer where a channel is formed is provided between two gates is used for the transistor 320. The two gates may be connected to each other and supplied with the same signal to operate the transistor. Alternatively, the threshold voltage of the transistor may be controlled by supplying a potential for controlling the threshold voltage to one of the two gates and supplying a potential for driving to the other of the two gates.

There is no particular limitation on the crystallinity of a semiconductor material used in the semiconductor layer of the transistor, and an amorphous semiconductor, a single crystal semiconductor, or a semiconductor having crystallinity other than single crystal (a microcrystalline semiconductor, a polycrystalline semiconductor, or a semiconductor partly including crystal regions) can be used. A single crystal semiconductor or a semiconductor having crystallinity is preferably used, in which case deterioration of the transistor characteristics can be inhibited.

The bandgap of a metal oxide used for the semiconductor layer of the transistor is preferably greater than or equal to 2 eV, further preferably greater than or equal to 2.5 eV. The use of such a metal oxide having a wide band gap can reduce the off-state current of the OS transistor.

The semiconductor layer provided in the OS transistor preferably contains indium. The semiconductor layer preferably contains indium, M (Mis one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, and magnesium), and zinc, for example. Specifically, Mis preferably one or more kinds selected from aluminum, gallium, yttrium, and tin.

For example, an oxide containing indium (InO_{X}) is preferably used for the semiconductor layer of the OS transistor. Alternatively, it is preferable to use an oxide containing indium and gallium (also referred to as IGO). Alternatively, it is preferable to use an oxide containing indium, gallium, and zinc (also referred to as IGZO). Alternatively, it is preferable to use an oxide containing indium, tin, and zinc. Alternatively, it is preferable to use an oxide containing indium, gallium, tin, and zinc.

Note that an oxide semiconductor used for the semiconductor layer of the OS transistor is suitably formed by a sputtering method or an ALD method. In the case where the oxide semiconductor is formed by a sputtering method, the productivity and the film density can be increased. In the case where the oxide semiconductor is formed by an ALD method, coverage with a film can be improved.

An OS transistor having a wider band gap and a lower carrier concentration than silicon can achieve an extremely low off-state current. Such a low off-state current enables long-term retention of electric charge accumulated in a capacitor that is connected in series with the transistor.

An OS transistor has much higher field-effect mobility than a transistor containing amorphous silicon. In addition, the OS transistor has an extremely low leakage current between a source and a drain in an off state (hereinafter also referred to as off-state current), and electric charge accumulated in a capacitor that is connected in series to the transistor can be retained for a long period. Furthermore, the power consumption of the display panel can be reduced with the OS transistor.

To increase the luminance of the light-emitting device included in the pixel circuit, the amount of current fed through the light-emitting device needs to be increased. To increase the current amount, the source-drain voltage of a driving transistor included in the pixel circuit needs to be increased. An OS transistor has a higher breakdown voltage between a source and a drain than a Si transistor; hence, high voltage can be applied between the source and the drain of the OS transistor. Therefore, when an OS transistor is used as the driving transistor included in the pixel circuit, the amount of current flowing through the light-emitting device can be increased, so that the luminance of the light-emitting device can be increased.

Assuming that the transistor operates in a saturation region, a change in the amount of current between the source and the drain, with respect to a fluctuation in the gate-source voltage, in the OS transistor is smaller than that in the Si transistor. Accordingly, when an OS transistor is used as the driving transistor included in the pixel circuit, a current flowing between the source and the drain can be set minutely in accordance with a change in gate-source voltage; hence, the amount of current flowing through the light-emitting device can be controlled. Consequently, the number of gray levels expressed by the pixel circuit can be increased.

Regarding saturation characteristics of a current flowing when transistors operate in a saturation region, even in the case where the source-drain voltage of an OS transistor increases gradually, a more stable current (saturation current) can be fed through the OS transistor than through a Si transistor. Thus, by using an OS transistor as the driving transistor, a stable current can be fed through light-emitting devices even when the current-voltage characteristics of the light-emitting devices vary, for example. In other words, when the OS transistor operates in the saturation region, the source-drain current hardly changes with an increase in the source-drain voltage; hence, the luminance of the light-emitting device can be stable.

As described above, with the use of an OS transistor as the driving transistor included in the pixel circuit, it is possible to achieve “reduction in power consumption”, “increase in emission luminance”, “increase in gray level”, “inhibition of variation in light-emitting devices”, and the like.

### [Display Panel 200E]

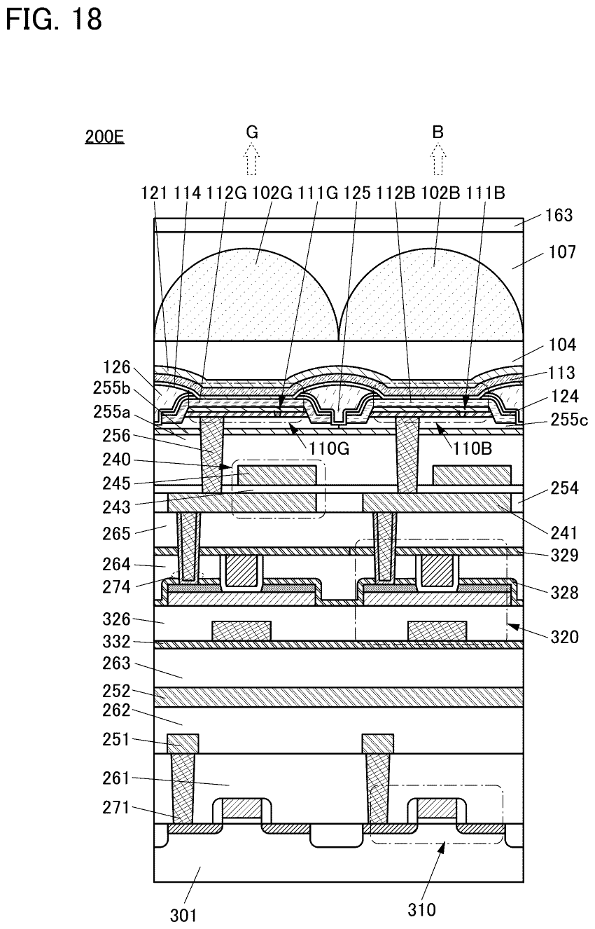

The display panel 200E illustrated in FIG. 18 has a structure where the transistor 310 having a channel formed in the substrate 301 and the transistor 320 containing a metal oxide in a semiconductor layer where a channel is formed are stacked.

The insulating layer 261 is provided to cover the transistor 310, and a conductive layer 251 is provided over the insulating layer 261. An insulating layer 262 is provided to cover the conductive layer 251, and a conductive layer 252 is provided over the insulating layer 262. The conductive layer 251 and the conductive layer 252 each function as a wiring. An insulating layer 263 and the insulating layer 332 are provided to cover the conductive layer 252, and the transistor 320 is provided over the insulating layer 332. The insulating layer 265 is provided to cover the transistor 320, and the capacitor 240 is provided over the insulating layer 265. The capacitor 240 and the transistor 320 are connected to each other through the plug 274.

The transistor 320 can be used as a transistor included in the pixel circuit. The transistor 310 can be used as a transistor included in the pixel circuit or a transistor included in a driver circuit for driving the pixel circuit (a gate line driver circuit or a source line driver circuit). The transistor 310 and the transistor 320 can also be used as transistors included in a variety of circuits such as an arithmetic circuit and a memory circuit.

With such a structure, not only the pixel circuit but also the driver circuit and the like can be formed directly under the light-emitting devices; thus, the display panel can be downsized as compared with the case where a driver circuit is provided around a display region.

### [Display Panel 200F]

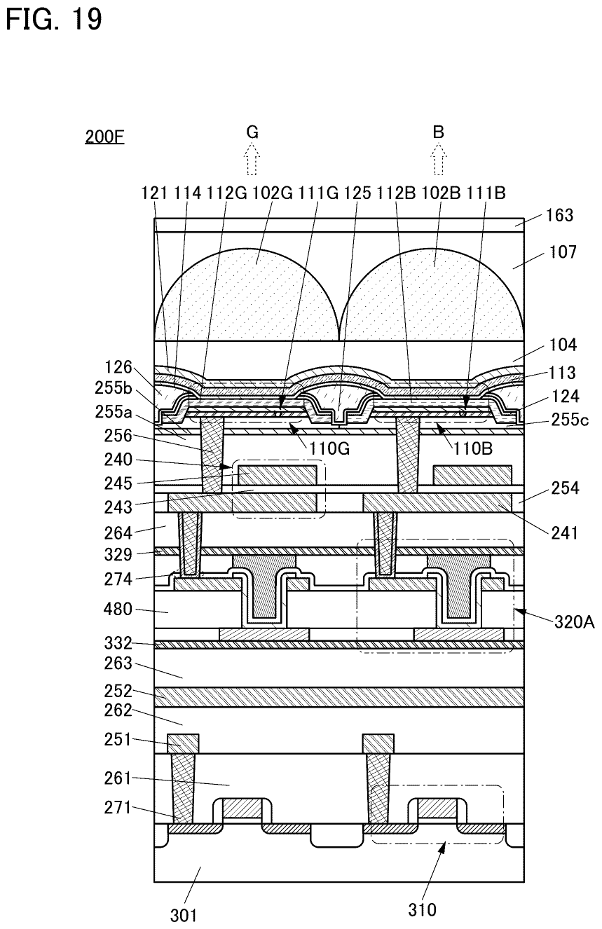

The display panel 200F illustrated in FIG. 19 has a structure where the transistor 320 in the display panel 200E illustrated in FIG. 18 is replaced with a transistor 320A (vertical transistor). Note that the structure where the transistor 320 is replaced with the transistor 320A can also be employed for the display panel 200D illustrated in FIG. 17.

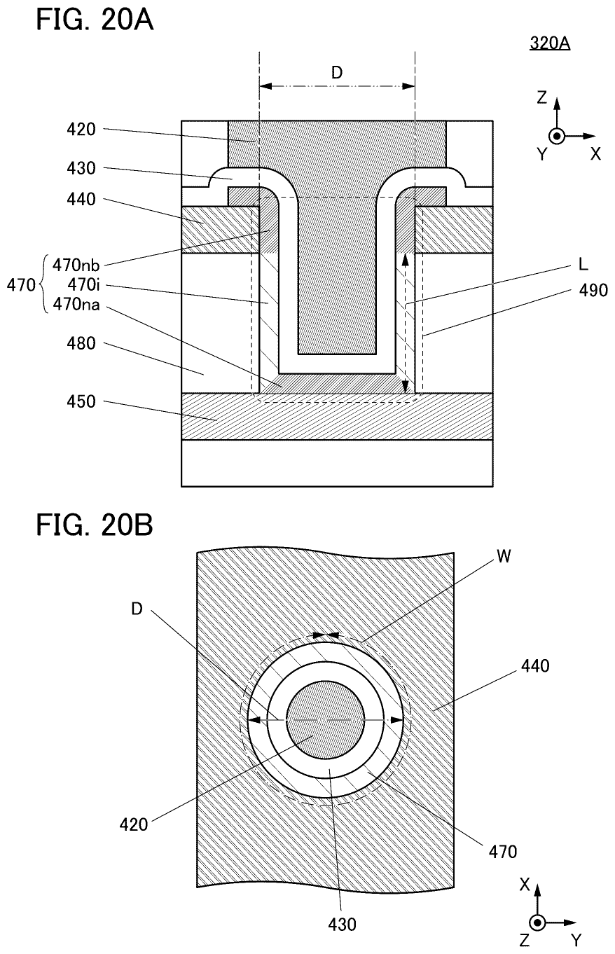

FIG. 20A is a cross-sectional view of the transistor 320A along the X-Z plane. FIG. 20B is a cross-sectional view along the X-Y plane including a wiring 440. FIGS. 20A and 20B each show arrows indicating directions of X, Y, and Z.

The transistor 320A includes an oxide semiconductor 470, an insulator 430, and a conductor 420. The oxide semiconductor 470 functions as a semiconductor layer, the insulator 430 functions as a gate insulator, and the conductor 420 functions as a gate electrode. A wiring 450 includes a region functioning as one of a source electrode and a drain electrode of the transistor 320A. The wiring 440 includes a region functioning as the other of the source electrode and the drain electrode of the transistor 320A.

An opening portion 490 penetrating the wiring 440 and an insulator 480 and reaching the wiring 450 is provided. The opening portion 490 has a pillar shape with a substantially circular top surface. This structure enables miniaturization or high integration of the memory cell. Note that the side surface of the opening portion 490 is preferably perpendicular to the top surface of the wiring 450. Note that the term “perpendicular” in this specification and the like indicates that the angle formed between two straight lines is greater than or equal to 85° and less than or equal to 95°.

At least part of the oxide semiconductor 470 is provided in the opening portion 490. Note that the oxide semiconductor 470 includes a region in contact with the top surface of the wiring 450, a region in contact with the side surface of the wiring 440, and a region in contact with the side surface of the insulator 480 in the opening portion 490.

The insulator 430 is provided so as to at least partly cover the opening portion 490. The conductor 420 is provided so that at least part of the conductor 420 is positioned in the opening portion 490. The conductor 420 is preferably provided so as to be embedded in the opening portion 490, and the top-view shape of the conductor 420 is preferably substantially circular for a higher integration degree.

As illustrated in FIG. 20A, the oxide semiconductor 470 includes a region 470i and regions 470na and 470nb provided with the region 470i interposed therebetween.

The region 470na is a region of the oxide semiconductor 470 that is in contact with the wiring 450. At least part of the region 470na functions as one of the source region and the drain region of the transistor 320A. The region 470nb is a region of the oxide semiconductor 470 that is in contact with the wiring 440. At least part of the region 470nb functions as the other of the source region and the drain region of the transistor 320A. As illustrated in FIG. 20B, the wiring 440 is in contact with all the perimeter of the oxide semiconductor 470. Thus, the other of the source region and the drain region of the transistor 320A can be formed along all the perimeter of a portion formed in the same layer as the wiring 440 in the oxide semiconductor 470.

The region 470i is a region interposed between the region 470na and the region 470nb in the oxide semiconductor 470. At least part of the region 470i functions as the channel formation region of the transistor 320A. That is, the channel formation region of the transistor 320A is formed in part of the oxide semiconductor 470 that is positioned in a region between the wiring 450 and the wiring 440. It can be said that the channel formation region of the transistor 320A is positioned in a region in contact with the insulator 480 or a region in the vicinity thereof in the oxide semiconductor 470.

The channel length of the transistor 320A is a distance between the source region and the drain region. That is, the channel length of the transistor 320A is determined by the thickness of the insulator 480 over the wiring 450. In FIG. 20A, a channel length L of the transistor 320A is indicated by a dashed double-headed arrow. The channel length L is a distance between an end portion of a region where the oxide semiconductor 470 and the wiring 450 are in contact with each other and an end portion of a region where the oxide semiconductor 470 and the wiring 440 are in contact with each other in a cross-sectional view. That is, the channel length L corresponds to the length of the side surface of the insulator 480 on the opening portion 490 side in the cross-sectional view.

The channel length of a planar transistor is limited by the light exposure limit of photolithography, and further miniaturization is difficult. By contrast, in one embodiment of the present invention, the channel length can be determined by the thickness of the insulator 480. Thus, the transistor 320A can have an extremely small channel length less than or equal to the light exposure limit of photolithography (e.g., less than or equal to 60 nm, less than or equal to 50 nm, less than or equal to 40 nm, less than or equal to 30 nm, less than or equal to 20 nm, or less than or equal to 10 nm, and greater than or equal to 1 nm, or greater than or equal to 5 nm). Accordingly, the transistor 320A can have a high on-state current.

In addition, as described above, the channel formation region, the source region, and the drain region can be formed in the opening portion 490. Thus, the area occupied by the transistor 320A can be reduced as compared with a conventional transistor in which the channel formation region, the source region, and the drain region are provided separately on the X-Y plane. Accordingly, the pixel density can be increased.

Such a s transistor including the channel formation region along the side surface of the insulator 480 in the opening portion 490 is referred to as a vertical transistor.

Furthermore, in the X-Y plane including the channel formation region of the oxide semiconductor 470, as illustrated in FIG. 20B, the oxide semiconductor 470, the insulator 430, and the conductor 420 are provided concentrically. Therefore, the side surface of the conductor 420 provided at the center faces the side surface of the oxide semiconductor 470 with the insulator 430 therebetween. That is, in the top view, all the perimeter of the oxide semiconductor 470 serves as the channel formation region. In this case, for example, the channel width of the transistor 320A is determined by the length of the perimeter of the oxide semiconductor 470. In other words, the channel width of the transistor 320A is determined by the maximum width of the opening portion 490 (the maximum diameter in the case where the opening portion 490 is circular in the top view). In FIGS. 20A and 20B, a maximum width D of the opening portion 490 is indicated by a dashed double-dotted double-headed arrow. In FIG. 20B, a channel width W of the transistor 320A is indicated by a dashed-dotted double-headed arrow. By increasing the maximum width D of the opening portion 490, the channel width per unit area can be increased and the on-state current can be increased.

In the case where the opening portion 490 is formed by a photolithography method, the maximum width D of the opening portion 490 is limited by the light exposure limit of photolithography. In addition, the maximum width D of the opening portion 490 is limited by the thicknesses of the oxide semiconductor 470, the insulator 430, and the conductor 420 provided in the opening portion 490. The maximum width D of the opening portion 490 is preferably, for example, greater than or equal to 5 nm, greater than or equal to 10 nm, or greater than or equal to 20 nm and less than or equal to 100 nm, less than or equal to 60 nm, less than or equal to 50 nm, less than or equal to 40 nm, or less than or equal to 30 nm. In the case where the opening portion 490 is circular in the top view, the maximum width D of the opening portion 490 corresponds to the diameter of the opening portion 490, and the channel width W can be “D×π”.

In the memory device of one embodiment of the present invention, the channel length L of the transistor 320A is preferably shorter than at least the channel width W of the transistor 320A. The channel length L of the transistor 320A of one embodiment of the present invention is greater than or equal to 0.1 times and less than or equal to 0.99 times, preferably greater than or equal to 0.5 times and less than or equal to 0.8 times the channel width W of the transistor 320A. This structure enables a transistor with favorable electrical characteristics and high reliability.

In the case where the opening portion 490 is formed to be substantially circular in the top view, the oxide semiconductor 470, the insulator 430, and the conductor 420 are provided concentrically. This makes the distance between the conductor 420 and the oxide semiconductor 470 substantially uniform, so that a gate electric field can be substantially uniformly applied to the oxide semiconductor 470.

It is preferable that the channel formation region of the transistor including an oxide semiconductor in the semiconductor layer contain less oxygen vacancies or have a lower concentration of impurities such as hydrogen, nitrogen, or a metal element than the source region and the drain region. For example, the concentration of aluminum in the channel formation region of the oxide semiconductor is preferably lower than or equal to 1×10²² atoms/cm³, further preferably lower than or equal to 1×10²¹ atoms/cm³, still further preferably lower than or equal to 1×10²⁰ atoms/cm³, yet further preferably lower than or equal to 5×10¹⁹ atoms/cm³, yet still further preferably lower than or equal to 1×10¹⁹ atoms/cm³, yet still further preferably lower than or equal to 5×10¹⁸ atoms/cm³, yet still further preferably lower than or equal to 1×10¹⁸ atoms/cm³.

In some cases, hydrogen in the vicinity of an oxygen vacancy forms a defect that is an oxygen vacancy into which hydrogen enters (hereinafter sometimes referred to as V_{O}H), which generates an electron serving as a carrier. Thus, it is preferable that the amount of V_{O}H be also reduced in the channel formation region. Thus, the channel formation region of the transistor is a high-resistance region having a low carrier concentration. Accordingly, the channel formation region of the transistor can be regarded as an i-type (intrinsic) or substantially i-type region.

The source region and the drain region of the transistor including an oxide semiconductor in the semiconductor layer are regions which have lower resistances than the channel formation region by having increased carrier concentrations because of containing more oxygen vacancies or more V_{O}H or having higher concentrations of impurities such as hydrogen, nitrogen, or a metal element. In other words, the source region and the drain region of the transistor are n-type regions having higher carrier concentrations and lower resistances than the channel formation region.

Although the opening portion 490 is provided so that the side surface of the opening portion 490 is perpendicular to the top surface of the wiring 450 in FIG. 20A and the like, the present invention is not limited thereto. For example, the side surface of the opening portion 490 may have a tapered shape.

At least part of this embodiment can be implemented in combination with any of the other embodiments and an example described in this specification as appropriate.

### Embodiment 3

In this embodiment, an indium oxide film that can be used for the semiconductor layer of the transistor included in the display panel of one embodiment of the present invention will be described.

Indium oxide is a semiconductor material having physical properties completely different from those of an oxide semiconductor such as an In—Ga—Zn oxide (hereinafter, also referred to as IGZO) or zinc oxide.

In this specification and the like, indium oxide including at least a crystal part or a crystal region in a film is referred to as crystal IO or crystalline IO. Examples of crystal IO or crystalline IO include single crystal indium oxide, polycrystal indium oxide, and microcrystal indium oxide.

Indium oxide is a semiconductor material having physical properties completely different from those of an oxide semiconductor such as an In—Ga—Zn oxide (hereinafter, also referred to as IGZO) or zinc oxide.

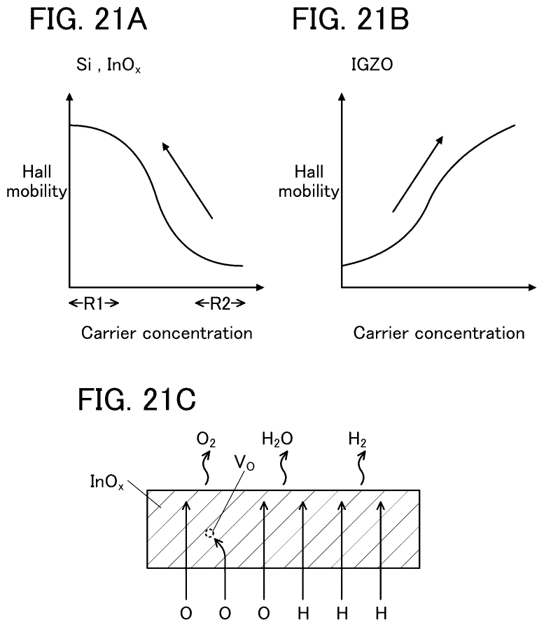

The dependence of the Hall mobility on the carrier concentration of indium oxide, silicon, and IGZO will be described. FIG. 21A is a schematic view showing the dependence of the Hall mobility on the carrier concentration of silicon (Si) and indium oxide (InO_{X}), and FIG. 21B is a schematic view showing the dependence of the Hall mobility on the carrier concentration of IGZO.

As indicated by an arrow in FIG. 21B, IGZO has a tendency in which the Hall mobility is higher as the carrier concentration is higher. By contrast, as indicated by an arrow in FIG. 21A, indium oxide has a tendency in which the Hall mobility is higher as the carrier concentration is lower (see Non-Patent Document 1). This tendency is similar to that of silicon; as the concentration of a dopant (impurity) in a material is lower, impurity scattering is inhibited more and thus the Hall mobility is higher. That is, indium oxide having higher purity and being more intrinsic has higher Hall mobility. Consequently, the physical properties of indium oxide are different from those of IGZO and similar to those of silicon. Note that the characteristics of indium oxide in FIG. 21A assume single crystal indium oxide; thus, the characteristics of non-single-crystal (e.g., polycrystal) indium oxide are sometimes different from those in FIG. 21A.

In FIG. 21A, the Hall mobility is extremely high in a range R1 with a low carrier concentration; thus, the range R1 can be regarded as a carrier concentration range suitable for a channel formation region of a transistor, for example. In the case of indium oxide, for example, the range R1 is a range including a carrier concentration of 1×10¹⁵ cm⁻³, e.g., a range with a carrier concentration higher than or equal to 1×10¹⁴ cm⁻³ and lower than or equal to 1×10¹⁸ cm⁻³. The adequately lowered carrier concentration will increase the Hall mobility to approximately 270 cm²/(V·s).

A region of indium oxide where the carrier concentration falls within the range R1 can include an element that reduces the carrier concentration. Examples of the element that reduces the carrier concentration include magnesium, calcium, zinc, cadmium, and copper. When indium is replaced with any of these elements, the carrier concentration can be reduced. Other examples of the element that reduces the carrier concentration include nitrogen, phosphorus, arsenic, and antimony. For example, when oxygen is replaced with nitrogen, phosphorus, arsenic, or antimony, the carrier concentration can be reduced.

A range R2 with a high carrier concentration has low electric resistance and is a carrier concentration range suitable for a source region and a drain region of a transistor, a resistor, or a transparent conductive film, for example. The range R2 is a range including a carrier concentration of 1×10²⁰ cm⁻³, e.g., a range with a carrier concentration higher than or equal to 1×10¹⁹ cm⁻³ and lower than or equal to 1×10²² cm⁻³. The adequately increased carrier concentration will decrease the resistivity to 1×10⁻⁴ Ω·cm or lower.

A region of indium oxide where the carrier concentration falls within the range R2 can include an element that increases the carrier concentration. For example, the region preferably includes the same element as a source electrode and a drain electrode of a transistor. Examples of the element that increases the carrier concentration include titanium, zirconium, hafnium, tantalum, tungsten, molybdenum, tin, silicon, and boron. It is particularly preferable that an oxide of the element have conductivity or semiconductor properties.

In this manner, the region with a low carrier concentration and the region with a high carrier concentration of indium oxide are used respectively as a channel formation region and source and drain regions of a transistor. That is, indium oxide can be regarded as an oxide whose valence electron can be controlled. As for IGZO, distortion due to stress of an electrode in contact with IGZO is formed in a source region and a drain region and n-type regions are formed in some cases. Since a valence electron can be controlled in indium oxide unlike in IGZO, formation of distortion can be inhibited in a film of indium oxide. The film with less distortion will have higher reliability. For example, when the region where the carrier concentration falls within the range R1 and the region where the carrier concentration falls within the range R2, which are shown in FIG. 21A, are separately formed in an indium oxide film, what is called an n-i-n junction (a junction between an n-type region, an i-type region, and an n-type region) can be formed. Although valence electron control in a transistor containing silicon is generally known, valence electron control in a transistor containing indium oxide is a novel technical idea that cannot be conceived usually.

With the use of the above technical idea, a transistor containing indium oxide in this specification and the like has two or more, preferably three or more, further preferably four or more, and most preferably all of the following features (1) to (5): (1) high on-state current (i.e., high mobility); (2) low off-state current; (3) normally-off characteristics; (4) high reliability; and (5) high cutoff frequency (fT). For example, the transistor containing indium oxide in this specification and the like can have high mobility, a low off-state current, and normally-off characteristics. The transistor is different from a normally-on transistor having high mobility.

Next, an indium oxide film used for a transistor will be described. The indium oxide film preferably has crystallinity (i.e., has a crystal grain). Examples of a film having a crystal grain include a single crystal film, a polycrystal film, and an amorphous film having a crystal grain (also referred to as a microcrystal film). In particular, the indium oxide film is preferably a polycrystal film, further preferably a single crystal film. A single crystal film does not have a crystal grain boundary (also referred to as a grain boundary). Impurities that block the carrier flow (typically, an insulating impurity, an insulating oxide, or the like) are likely to be segregated at a crystal grain boundary. The use of a single crystal film can inhibit carrier scattering or the like at the crystal grain boundary, thereby achieving a transistor having high field-effect mobility. In addition, the use of a single crystal film produces an excellent effect of reducing a variation in transistor characteristics caused by the crystal grain boundary.

A polycrystal film is preferable because it can reduce carrier scattering as compared with a microcrystal film or an amorphous film and enables a transistor to have high field-effect mobility. In the case of using a polycrystal film, it is preferable to use a film that has as large a crystal grain size as possible and few crystal grain boundaries. In the case where the crystal grain boundary is neither included nor observed in a channel formation region of a transistor including a polycrystal indium oxide film, the channel formation region is positioned in a single crystal region included in the polycrystal film and thus the transistor can be regarded as a transistor containing single crystal indium oxide.

The crystallinity of indium oxide can be analyzed with an X-ray diffraction (XRD) pattern, a transmission electron microscope (TEM) image, or an electron diffraction (ED) pattern, for example. Alternatively, two or more of these methods may be combined for the analysis.

In this specification and the like, a semiconductor layer where no crystal grain boundary is observed in a channel formation region, a semiconductor layer where a channel formation region is included in one crystal grain, or a semiconductor layer where the directions of crystal axes of at least two regions in a channel formation region are the same can be referred to as a single crystal film. A semiconductor layer where the direction of a crystal axis is continuously changed with another crystal axis or a crystal orientation as a rotation axis in one crystal grain in a channel formation region can also be referred to as a single crystal film.

A channel formation region refers to a region of a semiconductor layer that overlaps with (or faces) a gate electrode with a gate insulating layer therebetween and is positioned between a region in contact with a source electrode and a region in contact with a drain electrode. A current path in a channel formation region is the shortest distance between a source electrode and a drain electrode. Thus, a crystal grain, a crystal grain boundary, a crystal axis, a crystal orientation, or the like in a channel formation region can be confirmed in observation of a cross section including a semiconductor layer, a source electrode, and a drain electrode.

The impurity concentration in an indium oxide film in a channel formation region is preferably as low as possible. Impurities in the indium oxide film in the channel formation region can function as a carrier scattering source and cause a reduction in field-effect mobility. Such impurities might inhibit crystal growth of the indium oxide film. Examples of the impurities for the indium oxide film include boron and silicon. The concentrations of these impurities in the indium oxide film are each preferably lower than or equal to 0.1%, further preferably lower than or equal to 0.01% (100 ppm). Note that carbon, hydrogen, and the like are elements that would be contained in a film formation gas or a precursor in film formation, and the amounts of these elements remaining in the indium oxide film might be larger than those of the impurities.

The indium oxide film in the channel formation region may contain an element that can form a trivalent cation like indium as long as the cubic crystal structure (bixbyite structure) is retained. Examples of the element include Group 13 elements such as gallium and aluminum and Group 3 elements in the periodic table. Since these elements exist mainly as trivalent cations in oxides, the carrier concentration of indium oxide can be kept low.

A transistor including the above indium oxide film can have a field-effect mobility higher than or equal to 50 cm²/(V·s), preferably higher than or equal to 100 cm²/(V·s), further preferably higher than or equal to 150 cm²/(V·s), still further preferably higher than or equal to 200 cm²/(V·s), yet still further preferably higher than or equal to 250 cm²/(V·s).

One feature of an indium oxide film is to have a higher property of transmitting (diffusing) oxygen than an IGZO film. As shown in FIG. 21C, oxygen (O) diffusing in an indium oxide film (denoted as InO_{X}) is transmitted through the indium oxide film and released as an oxygen molecule (O₂). When reacting with hydrogen contained in the film, oxygen is released as a water molecule (H₂O) in some cases. In the case where the film includes oxygen vacancies (V_{O}), the oxygen vacancies are filled with diffusing oxygen atoms. Since oxygen easily diffuses in the indium oxide film, oxygen vacancies in the indium oxide film are filled with oxygen more easily than those in an IGZO film.

As described above, the oxygen vacancies in the indium oxide film are reduced more easily than those in the IGZO film; thus, a transistor including such an indium oxide film can have extremely high reliability.

As shown in FIG. 21C, hydrogen diffuses in the indium oxide film. Hydrogen diffusing into the indium oxide film from the outside is transmitted through the indium oxide film and is released as a hydrogen molecule (H₂). When reacting with oxygen contained in the film, hydrogen is released as a water molecule.

A transistor including an indium oxide film is an accumulation-type transistor in which electrons are majority carriers. Assuming that the relaxation time of carriers is constant, the electron mobility is higher as the effective mass of electrons (carriers) is smaller. That is, a transistor containing indium oxide with a small effective mass of electrons can have a high on-state current or high field-effect mobility.

Table 4 shows the effective mass in each of single crystal indium oxide (here, In₂O₃) and single crystal silicon (Si). As shown in Table 4, indium oxide has features of a small effective mass of electrons and a large effective mass of holes. In addition, the effective mass of electrons in indium oxide hardly depends on the crystal orientation. Thus, a transistor containing indium oxide having crystallinity can have high field-effect mobility and high frequency characteristics (also referred to as f characteristics). A large effective mass of holes allows a transistor to have an extremely low off-state current. For example, the off-state current per micrometer of channel width of a vertical transistor including an indium oxide film can be lower than or equal to 1 fA (1×10⁻¹⁵ A) or lower than or equal to 1 aA (1×10⁻¹⁸ A) at 125° C., and can be lower than or equal to 1 aA (1×10⁻¹⁸ A) or lower than or equal to 1 zA (1×10⁻²¹ A) at room temperature (25° C.). Since indium oxide has a smaller effective mass of electrons and a larger effective mass of holes than silicon as shown in Table 4, a transistor containing indium oxide can have higher field-effect mobility and lower off-state current than a Si transistor.

TABLE 4
Effective mass of In₂O₃

| Electron | | | |
|---|---|---|---|
| [100] | [110] | [111] | |
| direction | direction | direction | Hole |
| 0.17 | 0.18 | 0.19 | 3.56 |

Effective mass of Si

| Electron | Hole |
|---|---|
| 0.26 | 0.17 |

A seed layer is preferably provided in contact with at least part of the indium oxide film having crystallinity. A material of the seed layer is preferably selected such that the difference in a lattice constant (also referred to as lattice mismatch) between the crystal included in indium oxide and the crystal included in the material is small. In this case, the crystallinity of the indium oxide film can be improved. As a layer in contact with at least part of the indium oxide film having crystallinity, a substrate (e.g., a single crystal substrate) may be used.

One of methods for evaluating the degree of a lattice mismatch is a method using a value of a lattice mismatch degree described below. A lattice mismatch degree Δa [%] of a crystal included in a film to be formed (here, the indium oxide film) with respect to the crystal included in the seed layer is calculated by the formula: Δa=((L₁−L₂)/L₂)×100. Here, L₁ is the lattice constant or the length of the unit lattice vector of the crystal included in the film to be formed, and L₂ is the lattice constant or the length of the unit lattice vector of the crystal included in the seed layer.

The absolute value of the lattice mismatch degree Δa between the seed layer and the indium oxide film is preferably as small as possible, most preferably 0. For example, Aa can be greater than or equal to −5% and less than or equal to 5%, preferably greater than or equal to −4% and less than or equal to 4%, further preferably greater than or equal to −3% and less than or equal to 3%, still further preferably greater than or equal to −2% and less than or equal to 2%.

An indium oxide crystal has a cubic crystal structure (a bixbyite structure). For example, an yttria-stabilized zirconia (YSZ) crystal can have a cubic crystal structure (a fluorite crystal structure). The lattice mismatch degree of an indium oxide crystal with respect to an YSZ crystal having the cubic crystal structure is within the range of −2% to 2%, which enables epitaxial growth of a single crystal film of indium oxide over the YSZ substrate.

The crystal structures of the seed layer and the indium oxide film do not necessarily have the same crystal system or crystal orientation in some cases. For example, a film including a crystal with a hexagonal crystal structure or a trigonal crystal structure can be provided below an indium oxide film including a crystal with a cubic crystal structure. For example, when the crystal orientation of a seed layer surface is set to and the crystal orientation of a bottom surface of the indium oxide film is set to [111], the necessary condition for crystal orientation in epitaxial growth can be satisfied. Examples of a hexagonal or trigonal crystal structure include a wurtzite structure, a YbFe₂O₄ structure, a Yb₂Fe₃O₇ structure, and variations of these structures. An example of a crystal having a YbFe₂O₄ structure or a Yb₂Fe₃O₇ structure is IGZO.

At least part of this embodiment can be implemented in combination with any of the other embodiments described in this specification as appropriate.

This application is based on Japanese Patent Application Serial No. 2024-198931 filed with Japan Patent Office on Nov. 14, 2024, the entire contents of which are hereby incorporated by reference.

What is claimed is:

1. An optical element comprising:
a first multilayer film;
a second multilayer film;
a first optical component;
a second optical component; and
an adhesive,
wherein the first multilayer film is in contact with a first surface of the first optical component,
wherein the second multilayer film is in contact with a second surface of the second optical component,
wherein the adhesive is between and in contact with the first multilayer film and the second multilayer film,
wherein the first multilayer film comprises a stack of a first layer and a second layer with different refractive indices,
wherein the second multilayer film comprises a stack of a third layer and a fourth layer with different refractive indices, and
wherein the first optical component, the first multilayer film, the adhesive, the second optical component, and the second multilayer film each have a visible-light-transmitting property.

2. The optical element according to claim 1,
wherein the first optical component and the second optical component are each a lens formed of a resin material.

3. The optical element according to claim 1,
wherein the first surface has a concave surface, and
wherein the second surface has a convex surface.

4. The optical element according to claim 1,
wherein a thickness of the adhesive is greater than or equal to 0.1 μm and less than or equal to 1 μm.

5. The optical element according to claim 1, further comprising a spherical spacer between the first multilayer film and the second multilayer film.

6. The optical element according to claim 1,
wherein the first multilayer film and the second multilayer film act as beam splitters with different optical characteristics.

7. The optical element according to claim 6,
wherein when a reflectance of the first multilayer film is a and a reflectance of the second multilayer film is b, a relation of b=(1−2a)/(2−3a) is satisfied.

8. The optical element according to claim 1,
wherein the first layer and the third layer comprise a same material, and
wherein the second layer and the fourth layer comprise a same material.

9. The optical element according to claim 8,
wherein the first layer and the third layer each comprise a region in contact with the adhesive.

10. The optical element according to claim 8,
wherein the first layer comprises a region in contact with the first surface, and
wherein the third layer comprises a region in contact with the second surface.

11. An optical device comprising:
a linear polarizing plate;
a first retardation plate;
the optical element according to claim 1 as a half mirror;
a second retardation plate; and
a reflective polarizing plate,
wherein the linear polarizing plate, the first retardation plate, the half mirror, the second retardation plate, and the reflective polarizing plate are arranged in this order.

12. An optical device comprising:
a first reflective polarizing plate;
a first retardation plate;
the optical element according to claim 1 as a half mirror;
a second retardation plate; and
a second reflective polarizing plate,
wherein the first reflective polarizing plate, the first retardation plate, the half mirror, the second retardation plate, and the second reflective polarizing plate are arranged in this order.

13. An electronic device comprising:
the optical device according to claim 11; and
a display apparatus,
wherein the display apparatus comprises a light-emitting element and a transistor connected to the light-emitting element, and
wherein the transistor comprises a metal oxide in a channel formation region.

14. An electronic device comprising:
the optical device according to claim 12; and
a display apparatus,
wherein the display apparatus comprises a light-emitting element and a transistor connected to the light-emitting element, and
wherein the transistor comprises a metal oxide in a channel formation region.

15. The electronic device according to claim 13,
wherein the metal oxide is indium oxide.

16. The electronic device according to claim 14,
wherein the metal oxide is indium oxide.
